(19) United States
(12) Patent Application Publication
(10) Pub. No.: US 2018/0351888 A1
(43) Pub. Date: Dec. 6, 2018

(54) Electronic Communication Platform

(71) Applicant: Maiclein, LLC, Birmingham, MI (US)

(72) Inventor: Michael Maiclein Howard, Royal Oak, MI (US)

(21) Appl. No.: 15/612,482

(22) Filed: Jun. 2, 2017

(51) Int. Cl. H04L 12/58; G06Q 10/10; G06Q 30/02

(52) U.S. Cl. CPC H04L 51/046; H04L 51/16; H04L 51/32; G06Q 30/0255; G06Q 10/1095; G06Q 30/0208; H04L 51/38

(57) ABSTRACT

A plurality of methods are disclosed that may be performed in an electronic communication platform. According to one example method, notifications for electronic messages from a sender are controlled based on a user-assigned priority score for the sender. According to another example method, automatic acceptance of calendar event invitations is controlled based on a user-assigned priority score. In another example method, credits are awarded to users for completion of work tasks initiated in the electronic communication platform, and the credits are deducted from users for sending messages within the electronic communication platform and/or subscribing to feeds in the electronic communication platform. According to another example method, a recipient email address is disabled in response to actuation of a unsubscribe user interface element by a user, thereby preventing delivery of any additional messages to an inbox of the user from any sender. These, and other methods, are disclosed herein.

### TECHNICAL FIELD

The present disclosure relates to electronic communication, and more particularly an electronic communication platform.

### BACKGROUND

Today's online websites are littered with intrusive, deceiving, and sometimes dangerous advertising. Large conglomerate advertising networks proliferate nearly every website one sees and uses, particularly if they are “free” sites. The type of advertising that they promote in order to get “eyeballs” is an in-your-face, unavoidable experience that defaces websites, limits site utility and desirability, and can cause user frustration. In response to this, a number of browser plug-ins have been developed to disable these advertisements. Unfortunately, now the plug-ins themselves are turning into “replacement advertising” conduits. As advertisement conglomerates serve ads to websites, they build user profiles and attempt to target users with these profiles in order to achieve the highest advertising dollar when showing ads. This causes a privacy nightmare for the average web user as all of their data is tracked and used to target them with advertisements.

Additionally, on these and other websites, if someone wants stay informed about promotions and sales they sign up for email newsletters. They cannot control the frequency of messaging, or what type of information is in the newsletter—and it is often not what originally interested them. Furthermore, if they unsubscribe, they are simply confirming their email address to the publisher, so they can resell to their affiliates or similar. This is because the online advertising industry relies on users having one email address, or at the very least a primary email address they use most often.

Moreover, if someone wants to know ‘what's going on this weekend’, it takes great effort and time to research events, make plans, coordinate with friends, add items to the calendar, and similar. What's more, during the search the user gets bombarded with invasive advertising that increases their digital trail. The search history, salary, education level, race, etc. of the user all become known to search engines, and are shared with their advertising networks to better target users.

Last, if someone wants to be updated about his or her biggest interests, such as their children's picture day or recreation game, or when their favorite restaurant releases a new menu, no solution exists to automatically update them. Users are lucky if that interest shares a calendar or the menu online, and it is up to users to stay up to date on changes or they'll miss the event.

### SUMMARY

An example method of delivering an electronic message includes receiving, from a user, a user-assigned priority score for a sender, and controlling notifications to the user for electronic messages from the sender based on the user-assigned priority score for the sender.

An example method of scheduling electronic calendar events includes receiving, from a user, a user-assigned priority score for a sender, and controlling whether an incoming invitation sent from the sender to the user for a calendar event is automatically accepted based on the user-assigned priority score.

An example method of facilitating communication within an electronic communication platform includes awarding credits to users for completion of work tasks initiated in the electronic communication platform, and deducting credits from users for sending messages within the electronic communication platform, subscribing to feeds in the electronic communication platform, or both.

An example method of facilitating communication between a user of an electronic communication platform and an external recipient includes receiving a request from a user of the electronic communication platform to send a message to a recipient email address of a recipient, automatically generating a new email address for a communication thread between the user and the recipient based on the request, and sending the message to the recipient email address. The sent message includes the new email address as a sender email address and enables the recipient to contact the user within the electronic communication platform via email.

An example method of facilitating communication includes presenting an unsubscribe user interface element to a user in conjunction with the delivery of a message from a particular sender to the user that is addressed to an email address of the user, and disabling the email address in response to actuation of the unsubscribe user interface element by the user, thereby preventing any additional messages addressed to the disabled email address from delivery to an inbox of the user.

An example method of facilitating communication within an electronic communication platform includes delivering, within the electronic communication platform, advertisement messages from an organization to users that subscribe to the organization within the electronic communication platform. Once a quantity of users that subscribe to the organization within the electronic communication platform has reached a threshold quantity of n subscribers, a subscription fee for subscribing to the organization within the electronic communication platform for any new subscribers beyond the existing n subscribers is temporarily increased from a first amount to a second amount until the organization purchases capacity for additional subscribers in the electronic communication platform.

An example method of facilitating communication within an electronic communication platform includes receiving an advertisement message from an organization, and identifying a plurality of users of the electronic communication platform as recipients for the message. For each identified user, the advertisement message is delivered without an indicator that the message is an advertisement if the user has subscribed to the organization within the electronic communication platform, and is delivered with an indicator that the message is an advertisement if the user has not subscribed to the organization within the electronic communication platform.

An example method of delivering electronic messages includes receiving, in an electronic communication platform, a message from a sender, the message having a corresponding first appropriateness rating. The message is delivered to a recipient if the recipient is currently using a first device to access the electronic communication platform, the first device being authorized to receive messages having the first appropriateness rating. Delivery of the message to the recipient is postponed if the recipient is currently using a second device to access the electronic platform, the second device being unauthorized to receive messages having the first appropriateness rating.

### BRIEF DESCRIPTION OF THE DRAWINGS

FIG. 1 schematically illustrates interaction between plurality of users and organizations and an electronic communication platform.

FIG. 2 illustrates a flowchart of example aspects of the electronic communication platform of FIG. 1.

FIG. 3 illustrates a flowchart of additional example aspects of the electronic communication platform of FIG. 1.

FIG. 4 illustrates an example points screen of the electronic communication platform of FIG. 1.

FIG. 5 schematically illustrates an example method of facilitating communication in the electronic communication platform of FIG. 1.

FIG. 6 schematically illustrates another method of facilitating communication in the electronic communication platform of FIG. 1.

FIG. 7 illustrates an example flowchart of features relating to subscribing to an information feed in the electronic communication platform of FIG. 1.

FIG. 8 schematically illustrates an example method of delivering an electronic message in the electronic communication platform of FIG. 1.

FIG. 9 illustrates an example message received in the electronic communication platform of FIG. 1.

FIG. 10 schematically illustrates an example method of scheduling electronic calendar events in the electronic communication platform of FIG. 1.

FIG. 11 illustrates an example event invitation in the electronic communication platform of FIG. 1.

FIG. 12 schematically illustrates an example method of facilitating communication between a user of the electronic communication platform of FIG. 1 and an external recipient.

FIG. 13 schematically illustrates an example method of facilitating communication within the electronic communication platform of FIG. 1.

FIG. 14 schematically illustrates an example method of facilitating communication within the electronic communication platform of FIG. 1.

FIG. 15 illustrates an example landing page for an organization.

FIG. 16 schematically illustrates an example computing device that may be used in the electronic communication platform 20 of FIG. 1.

FIG. 17 schematically illustrates example aspects of an information feed in the electronic communication platform of FIG. 1.

FIG. 18 schematically illustrates example aspects of a subscription in the electronic communication platform of FIG. 1.

FIG. 19 schematically illustrates example aspects of work in the electronic communication platform of FIG. 1.

FIG. 20 schematically illustrates example aspects of points in the electronic communication platform of FIG. 1.

FIG. 21 schematically illustrates example aspects of a user account in the electronic communication platform of FIG. 1.

FIG. 22 schematically illustrates example aspects of a universal inbox in the electronic communication platform of FIG. 1.

FIG. 23 schematically illustrates example aspects of a publisher profile in the electronic communication platform of FIG. 1.

FIG. 24 schematically illustrates an example method of delivering electronic messages in the electronic communication platform of FIG. 1.

The embodiments described herein may be taken independently or in any combination. Features described in connection with one embodiment are applicable to all embodiments, unless such features are incompatible.

### DETAILED DESCRIPTION

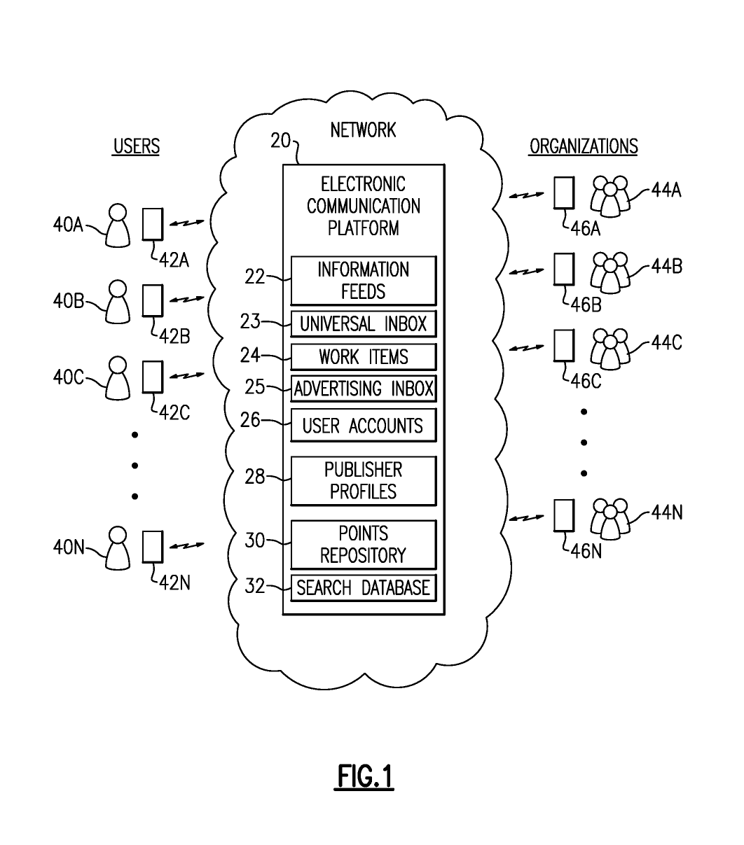

FIG. 1 schematically illustrates how a plurality of different users 40 and organizations 44 interact with an electronic communication platform 20 (referred to simply as the “platform” herein). The platform 20 provides a unified platform for acquiring information from a plurality of different sources. The platform 20 includes information feeds 22 for delivering information to users 40A-N. Some of the information feeds 22 may be provided by organizations 44A-N. The organizations could be any one or more of a number of different entities, such as companies, governmental groups, school groups, restaurants, entertainment venues, charities, churches, athletic leagues, recreation teams, or any group that has a desire to organize an event or information, whether publicly or privately.

In on example, a school provides an information feed 22 for upcoming events occurring for students. As another example, a company may provide an information feed 22 of its latest product offerings, and may provide additional feeds 22 for additional product lines and/or company related events (e.g., happy hours, sales, parties, etc.). As another example, a municipal government could provide an information feed in the platform 20 for informing residents of upcoming events, updates on initiatives, updates on civil services (e.g., trash pickup day), etc.

Users 40 may also provide information feeds 22 on an individual or crowdsourced basis. This can be performed for general topics of interest (e.g., motorcycles, photography, guitars, etc.) or can be performed for organizations 44 that do not have an official presence in the platform 20 (e.g., an unofficial company information feed 22 in the platform).

Each user 40 in the platform 20 has a universal inbox 23 that can be used for receiving messages from friends/contacts and from information feeds 22 to which the user subscribes. The universal inbox 23 self-organizes by user-assigned priority scores and read/unread status of messages, and in some examples includes automatic self-cleaning/archival features. In some examples, the universal inbox 23 provides a self-cleaning feature by automatically self-archives messages after N days.

Some examples of the types of messages that can be delivered to the universal inbox 23 include the following:
Email newsletters
Direct messages between users 40
Short message service (SMS) messages
Multimedia messaging service (MMS) messages
Social media feeds
Blog feeds (e.g., RSS or ATOM feeds)
Email messages
Autonomous messages from Internet connected devices or appliances (e.g., Internet of things “IoT” devices)
Event invitations/messages
Private communications between verified organizations (e.g., account statements, notifications, etc.) and users
Available work items 24.

As used herein a “verified” organization 44 is one that has an account in the platform 20, and for which the identity of the organization 44 has been verified to be authentic. This provides a level of trust that when a message is received from the organization 44 it does not contain malware or other spam content.

In some examples, only more recent posts from a given information feed 22 may be shown in the universal inbox 23 (e.g., from the last 15 days), while archival posts would be available to users 40 elsewhere in the platform 20.

The platform 20 includes work items 24 which provide opportunities for users 40 to accumulate points within the platform 20. The points act as credits that the users 40 can redeem for sending messages, subscribing to information feeds 22, or in some examples obtaining goods or services (such as retailer or restaurant gift cards). The work items 24 can include viewing advertisements, taking surveys, and answering questionnaires, for example. Other additional work items are possible as well, and these will be discussed in greater detail below. In some examples, the work items 24 are delivered to users 40 in the users' respective advertising inboxes 25.

The platform 20 includes user accounts 26 for each of the users 40. The platform 20 also includes publisher profiles 28 for publishers that provide information feeds 22 (e.g., individual users 40, groups of users 40, or organizations 44), and a points repository 30 which tracks accumulation and spending of points within the platform 20.

Receipt of unsolicited or undesired electronic messages, also known as “spam,” is a problem that has plagued email service providers for many years. The platform 20 includes several features to combat spam. A first example feature is to charge users 40 to originate and/or send messages within the platform. The charges could be a debit of an actual dollar amount, a debit of the user's points (e.g., of an in-platform currency), and/or a requirement to engage in work to earn points. The business model of spammers relies upon sending millions of email messages for an extremely low rate of user engagement. This business model would no longer make sense if users 40 are charged to send messages in the platform 20.

Another example feature to disincentivize the sending of spam includes a feature that links unsubscribing to disabling an email address. The online advertising industry has traditionally relied on users having one email address. Additionally, the reliability of email “unsubscribe” links has traditionally relied entirely on whether the sender is reputable and chooses to honor the request, or is disreputable and chooses to ignore the request. Unsubscribe links are of limited effectiveness if one spammer shares an email address with other spammers.

In some examples of the platform 20, each email conversation is managed by the users 40 with the ability to disable the email address to which the message was addressed. This would prevent the original spammer and any other additional spammers from continuing to use the email address to send unsolicited messages.

The email address disable feature works in conjunction with another aspect of the platform 20 in which a user can use multiple email addresses that are automatically generated by the platform 20. Traditionally, users have used a single email address, or perhaps two email addresses (e.g., one for personal, one for work). In this arrangement, users share their email address(es) widely, and easily become susceptible to SPAM.

In one aspect of the platform 20, user email addresses are automatically generated when a user 40 initiates communication with someone outside of the platform 20. In this regard, users 40 can in some examples have a unique email address used for each communication thread (e.g., email address 1 for mom, email address 2 for dad, email address 3 for group chat with mom and dad, etc.). When one wishes to terminate the thread or cease communication with the party/parties they can unsubscribe from the thread and the platform 20 disables the email address, thereby preventing any additional messages addressed to the disabled email address from delivery to an inbox of the user. This protects the privacy of users 40 of the platform 20 and provides for a true unsubscribe feature. In another aspect of the platform 20, users 40 can create email addresses upon request as well (i.e., even when the user is not presently trying to initiate communication with someone outside of the platform 20).

To offset the cost of sending messages in the platform 20, work items 24 are provided to users 40 in the platform 20. Users 40 can obtain points in the platform 20 by performing work tasks, by purchasing points, or a combination of the two. Some example work tasks include taking surveys, viewing advertisement videos, rating branding and/or logo ideas, questionnaires, etc.

Another example work opportunity could include reviewing crowdsourced messages for quality and/or appropriateness before those crowdsourced messages are distributed to a larger audience in the platform 20. This review process could reduce and/or eliminate “trolling” within the platform 20, by preventing the delivery of abusive and/or offensive messages to a broader audience.

Users 40 can also be rewarded for submitting messages to a crowdsourced publication (i.e., an information feed 22). Imagine, for example, that a shoe retailer does not directly utilize the platform 20. One or more users 40 could generate a crowdsourced publication 22 for that shoe retailer to fill that void. Although the users 40 may be charged a nominal fee to initially submit their crowdsourced messages, they could be reimbursed and/or paid beyond reimbursement from in-platform subscription fees of users 40 that subscribe to the crowdsourced publication. A portion of the subscription fees could also be paid to the users 40 that review the submissions for quality and/or appropriateness.

These features provide an “information economy” that uses financial incentives to enable users 40 to receive only information they desire without intrusive spam (and in some examples without intrusive content network advertisements that are so prevalent on the Internet today) while still protecting user 40 privacy. The information economy also disincentivizes bad behaviors like spamming and trolling.

One aspect of the information economy is that actual personal data of users may be hidden from organizations 44. In the prior art, signing up for a mailing list often requires providing one's email address, name, and potentially even address or phone number, potentially exposing the individual to unwanted spam in the future. Moreover, visiting advertiser websites in the prior art to simply look up commonly needed information can also provide the advertiser significant information such as one's location, device type/information, and can expose the user to third party tracking cookies and/or permanent and non-removable unique tracking tags. The platform 20 obscures personal information from organizations 44 in some examples, and only permits the organizations 44 to select target demographics which the platform 20 determines in delivering its messages, such that the organizations 44 may be unaware of the actual identities of their subscribers.

Another example aspect of the information economy is the rich analytics data that can potentially be provided to publishers of information feeds 22 (i.e., organizations 44 or users 40 that provide information feeds 22). This could be based in part on how users 40 interact with the publisher messages they receive in their universal and/or advertising inboxes 23, 25. This could include, for example the best frequency, length, and type of communication (e.g., newsletter, RSS feed, etc.), and/or could include most watched/click social media posts. Such features could be valuable for organizations 44 trying to maximize the effectiveness and reach of their information feeds 22 and/or advertisements.

A keyword search tree feature could be provided to allow users 40 to find relevant organizations 44 and information feeds 22 within the platform 20. In one example, users 40 search on a keyword, and after the search they are presented with the results, but they are also presented with the most common keywords associated with that keyword. If they click on another keyword, the platform 20 searches the combination of two keywords for the most accurate results. This is considered 2 branches of keywords into the users search. This can continue, until the user has combined a threshold number of keywords (e.g., 6 keywords) to find the data they desire. Because of this, publishers may pick their keywords based on most common searches in order to be found how/where they want and against the appropriate competition.

The platform 20 also includes a search database 32 or searching the content of the platform 20, including its various information feeds 22, organizations 44, messages, and events. Some example search features that could be utilized include any combination of keyword searching, smart keyword tree searching (i.e., offering next most popular keywords based on a last keyword combined with others in a tree), domain searching, zip code searching, location searching, etc.

In one example organizations 44 can promote upcoming events, such as happy hours, through the platform 20, and those events could be provided as search results when a user 40 happens to be in proximity to the location of the event. For example, if visiting a new city or locale, a user 40 could search for upcoming nearby events, and could learn about an event (e.g., a happy hour) that they may be otherwise unaware of. They could then subscribe to an information feed 22 of the organization 44 providing the event in the platform 20 if desired.

The platform 20 includes numerous other features, including delivering, presenting, and responding to messages based on a user-assigned priority level for a sender, which will be discussed in greater detail below.

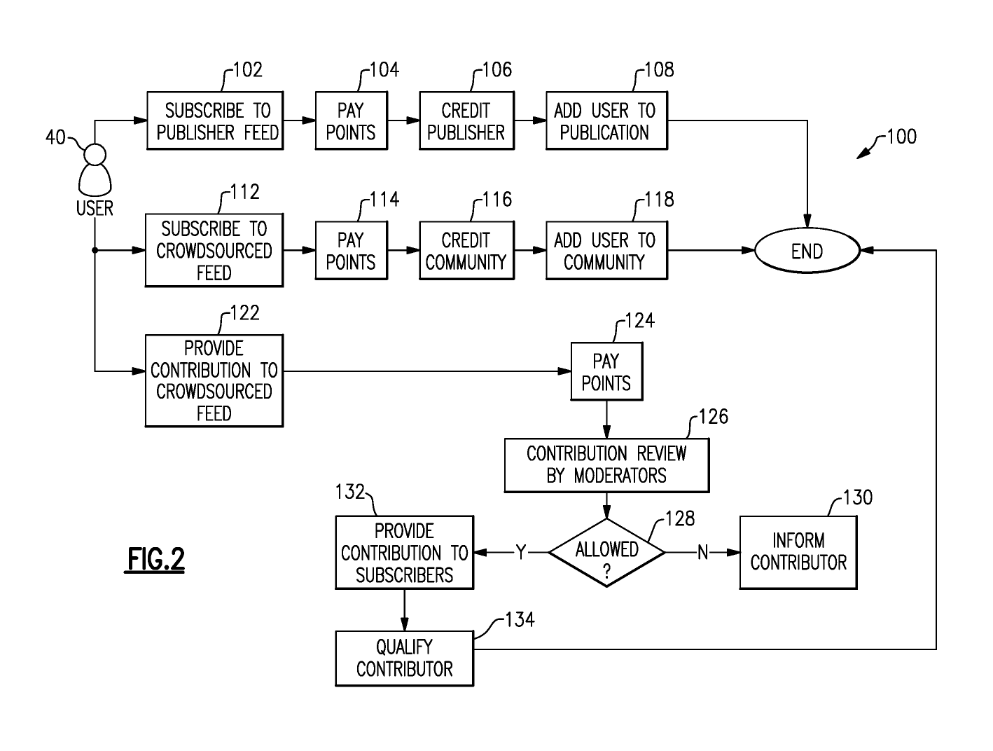

Referring now to FIG. 2, a flowchart 100 of example aspects of the platform 20 is shown. In a first aspect, a user 40 requests to subscribe to a publisher information feed (block 102). The “publisher” is the entity that provides the publication, such as a user 40, a group of users (crowdsourced publication), or an organization 44. The user 40 pays points for that subscription (block 104). Those fees are used to credit the publisher that provides the feed (block 106), and the subscribing user 40 is added to the publication (block 108), enabling the user 40 to receive messages from the publication in their universal inbox 23, and to view a repository of content (e.g., past messages and events) from the publication.

In another aspect, a user 40 requests to subscribe to a crowdsourced information feed 22 (block 112), such as one for an organization 44 that does not officially participate in the platform 20. The user 40 pays points for that subscription (block 114). Those fees are used to credit the community that maintains the crowdsourced information feed 22 (block 116), such as those who submit crowdsourced messages and/or review those crowdsourced messages for quality and/or appropriateness. The subscribing user 40 is added to the community (block 118).

In another aspect, a user 40 submits a contribution to a crowdsourced information feed 22 (block 122), pays points for the contribution (block 124), and the contribution is reviewed for quality and/or appropriateness by moderators (block 126). If the contribution is rejected (a “no” to block 128), then the submitting user is notified (block 130). If the contribution is approved (a “yes” to block 128), then the contribution is provided to the various non-moderator subscribers of the crowdsourced information feed 22 (block 132), and the user 40 is qualified as a contributor to the crowdsourced information feed 22 (block 134), enabling the user 40 to earn points for their contributions (e.g., from points paid by other users to subscribe to the information feed 22).

Periodically, subscription fees for the crowdsourced information feed 22 are divided amongst the qualified contributors and the moderators that review submissions for the feed as compensation. The allocation could be based upon how many contributions and how much moderating was performed by the qualified contributors within a given time period. In some examples, the points paid in block 124 are used to compensate the moderators that review the submissions to the crowdsourced feed.

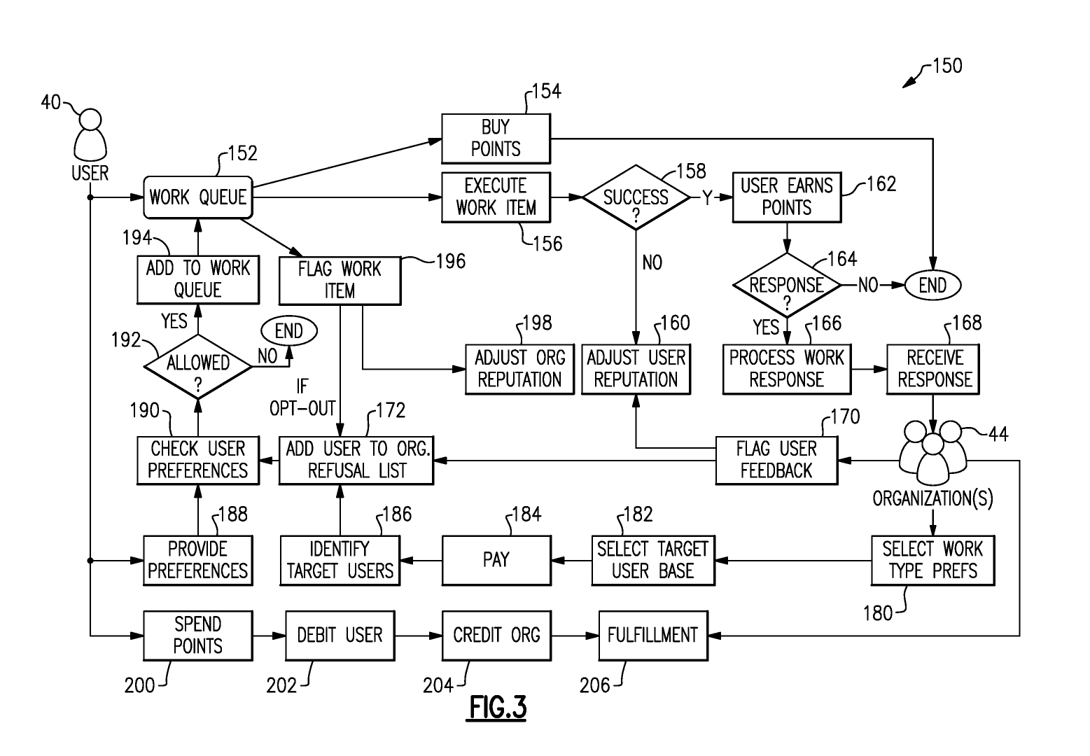

FIG. 3 illustrates a flowchart 150 of additional example aspects of the platform 20. User 40 has a work queue 152 that includes a plurality of work items 24. The work items 24 provided targeted opportunities for the user 40 to earn points in the platform 20. The targeting can be based on the user's interests and/or demographic information, for example. Despite having the work queue 152, the user 40 may nevertheless choose to buy points (block 154). In addition or as an alternative to buying points, the user 40 can execute a work item from their work queue 152 (block 156). If the user rejects a work item or does not successfully complete the work item (a “no” to block 158), then the user's reputation, and/or the reputation of the organization providing the work item is adjusted accordingly (block 160). In one example, a reputation adjustment is performed for un-successfully completed work items, but is not performed for rejected work items.

Unsuccessful completion of a work item could include detection of cheating or fraudulent behavior (e.g., trying to earn points without doing the accompanying work of a work item, such as having a bot move one's mouse cursor to give the impression of user presence). Adjustment of the user's reputation in some examples affects how much they are paid for work items, the degree to which they are provided with new work items, or a combination thereof. For example, if users are fraudulently or generally poorly performing work, then the platform 20 may pay them less for performing future work and/or may present them with fewer work opportunities until their reputation improves. If a user's reputation continues to drop and falls beneath a threshold, then the user may be banned from receiving additional work items on a temporary or permanent basis.

If the work item is successfully completed (a “yes” to block 158), then the user is awarded points (block 162). If the work item does not require a response (a “no” to block 164), the process ends. Otherwise, if the work item does require a response (e.g., a survey or questionnaire) (a “yes” to block 164), that work response is processed (block 166) and provided to the organization 44 paying for the work item (block 168).

If the organization 44 flags the user feedback as being suspicious or of low quality (block 170) then the user's reputation is adjusted (block 160). Optionally, the organization 44 may ban the user from performing work from them by adding them to a “refusal list” (block 172).

When providing work items 24 in the platform 20, organizations 44 are able to specify a type of the work and preferences for the work (block 180). The work type could include one or more of the following for example: watch video, take survey, comment on logos. The preferences for the work item could include completion criteria (e.g., time frame for availability of the work item, points offered for completion of the work item, etc.).

The organization 44 selects the target user base for the work item 24 (block 182), which could include selecting a demographic and quantity of users, for example. The organization 44 submits payment for the work item 24 (block 184). In one example, the payment is a prepayment of the amount of points needed for a given quantity of users to perform the work item (e.g., points for 10,000 users to view a video). The platform 20 identifies target users 40 as recipients for the work item in question based on the organization's preferences (block 186), which excludes users 40 on the refusal list (block 172).

Users 40 provide their work preferences (e.g., work that they want, work they do not want to perform, categories of work allowed or disallowed, type of work, length of work) (block 188). The platform 20 consults those preferences (block 190) and if a given work item identified for that user 40 is allowed (a “yes” to block 192) and not precluded by their preferences or the refusal list, the work item 24 is added to their work queue 152 (block 194).

Similar to how organizations 44 can review users 40, users 40 can also review organizations 44 by flagging work items that the user considers to be spam, inappropriate, or exhibit a generally low quality (block 196). Based on this, the platform 20 may adjust the organization's reputation (block 198), and if the user 40 opts out of the organization's work items then the user 40 adds themselves to the refusal list for the organization (block 172).

Having earned and/or purchased points, the user 40 can spend those points (block 200), causing the platform 20 to debit the user (block 202), credit the organization 44 providing the purchased item (block 204), and then fulfill the order (block 206). The purchased item could include an online service, a subscription, or a material item, for example. Alternatively, as discussed above, points could be spent on sending messages or subscribing to information feeds 22.

FIG. 4 illustrates an example points screen 220 that includes a points purchase area 222, a points ledger 226, and a combined work queue/points redemption area 230. The points purchase area 222 includes various user interface elements 224A-D for purchasing different levels of points. The points ledger 226 indicates a current balance 228A and a projected balance 228B. The projected balance 228B indicates what the user's point balance is expected to be when upcoming debits happen (e.g., based on current subscriptions and/or historic levels of message transmission by the user 40).

The combined work queue/points redemption area 230 includes a plurality of available work items 232 and a points redemption item 234. Each available work item 232 indicates an organization 44 behind the work item, an amount of points being offered, and a brief description of the work item. For example, the US Census Bureau work item offers 100 points to take a 25 question survey. Points redemption item 234 is for a gift card from NORDSTROM and costs 5,000 points. Of course, it is understood that these are only examples, and that other work items 232 and points redemption items 234 could be provided. Also, it is possible that the work items 232 and points redemption items 234 could be displayed separately and not in a combined fashion as shown in FIG. 4.

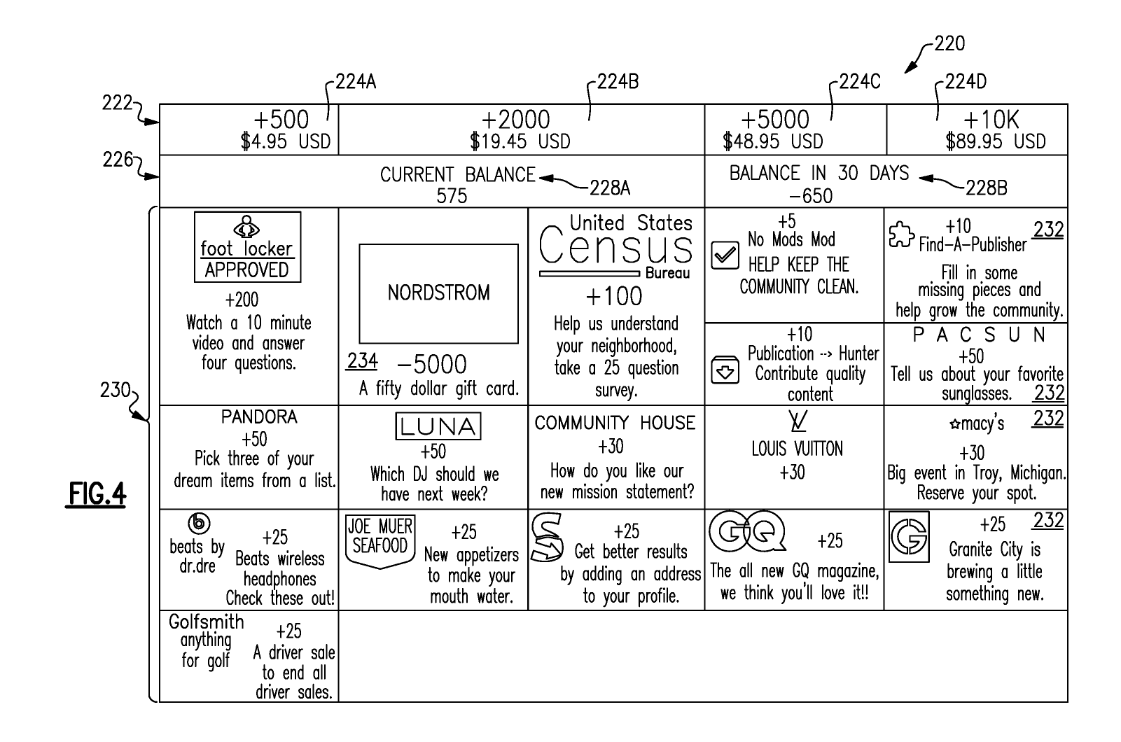

FIG. 5 schematically illustrates an example method 250 of facilitating communication within the platform 20. Credits are awarded to users 40 for completion of work tasks initiated in the platform 20 (block 252), and credits are deducted from users 40 for sending messages within the platform 20, subscribing to feeds in the platform 20, or both (block 254).

Various fee arrangements could be used for publications. In one example, an organization 44 pays for their information feed 22 within the platform 20 and it is free for users 40 to subscribe to the feed. In another example, both the organization 44 and the subscribing users 40 pay for the information feed 22. In another example, the organization 44 is not charged for the first n subscribers to their feed, but then must pay for any subscribers beyond the nth subscriber. This could incentivize organizations 44 to participate in the platform 20, and could further incentivize them to upgrade their account once they are approaching n subscribers in order to avoid alienating additional potential subscribers (e.g., by shifting the cost of subscription onto the subscribers until additional capacity is purchased).

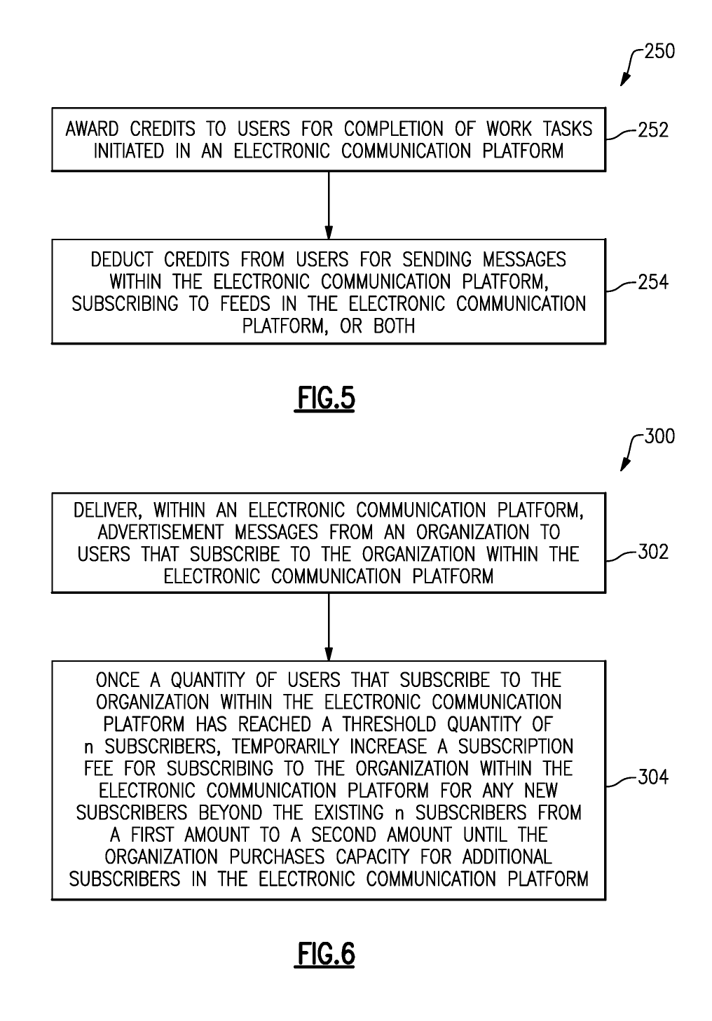

FIG. 6 schematically illustrates an example method 300 of facilitating communication within the platform 20. Advertisement messages are delivered within the platform 20 from an organization 44 to users 40 that subscribe to the organization 44 within the electronic communication platform 20 (block 302). Once a quantity of users 40 that subscribe to the organization 44 within the platform 20 has reached a threshold quantity of n subscribers, a subscription fee for subscribing to the organization 44 within the platform 20 for any new subscribers beyond the existing n subscribers is temporarily increased from a first amount to a second amount until the organization 44 purchases capacity for additional subscribers in the platform 20 (block 304). In some examples, the first amount is zero.

The method 300 incentivizes organizations 44 to purchase additional capacity for their subscribers so that the organization 44 can avoid alienating potential new subscribers with the temporarily adjusted fee. The subscription fee may be lowered from the second amount back to the first amount once the organization 44 purchases additional capacity.

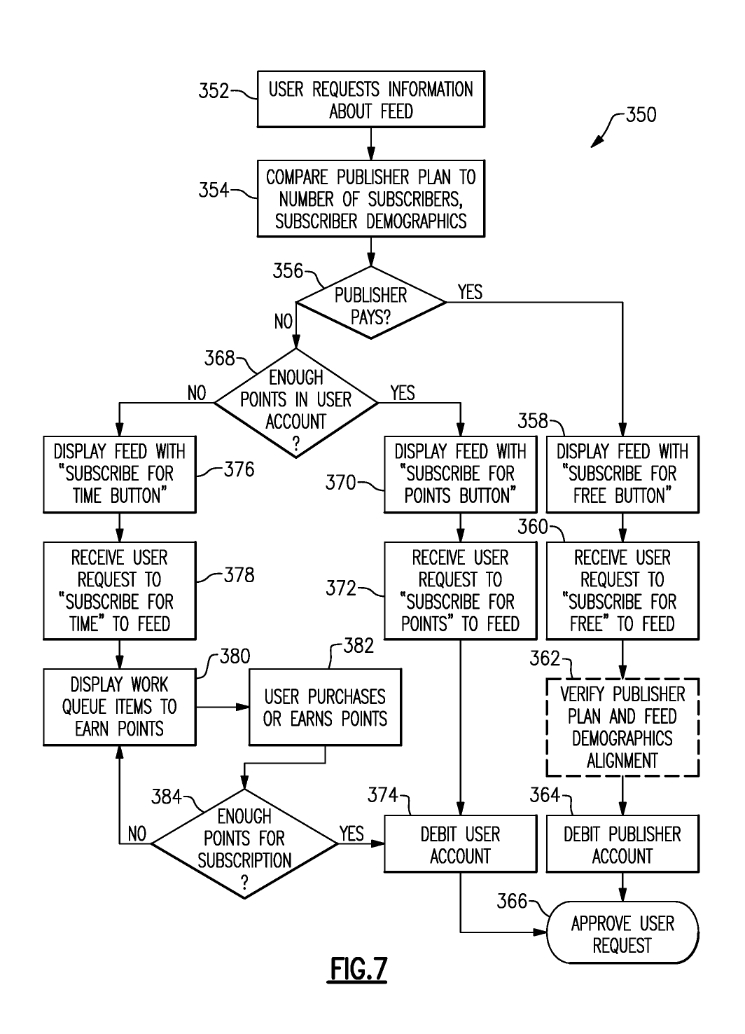

FIG. 7 is a flowchart 350 of additional features relating to subscribing to an information feed 22 (e.g., a publisher or crowdsourced feed). A user 40 requests information about a feed (block 352). For example, the user 40 may visit a landing page for the feed. The publisher's plan is compared to its number of subscribers and/or subscriber demographics (block 354) to determine if the publisher bears the cost of paying for additional subscribers. If the publisher pays (a “yes” to block 356), a “subscribe for free” menu item is displayed to the given user 40 for the information feed 22 (block 358), and selection of the menu item is detected (block 360).

Optionally, an alignment between the publisher's plan and the demographics of the requesting user are verified (block 362) to determine if the publisher should be charged, and if a charge is approved the publisher's account is debited (block 364), and the user's request is approved (block 366).

The verification of block 360 may be useful to ensure that publishers are only charged for users 40 in their desired demographic group. For example, if one's target demographic is 50-60 year olds and a 20 year old subscribes, that subscriber may be of lesser value to the publisher. In some examples, publishers are not charged for subscribers outside of the publisher's desired demographic. In other examples, block 360 is omitted and publishers whose plans require them to pay for subscribers are charged for all subscribers.

If it is determined that the publisher does not need to pay (a “no” to block 356), a determination is made of whether the user 40 has sufficient points in their account to subscribe to the feed (block 368). If the user 40 has sufficient points, a “subscribe for points” menu item is displayed (block 370), the user 40 selects the menu item (block 372), and the user's account is debited (block 374).

Otherwise, if the user 40 lacks sufficient points (a “no” to block 368), a “subscribe for time” menu option is presented to the user 40 (block 376) and the menu option is selected (block 378), granting the user 40 temporary access to the information feed 22. Work queue items are displayed to the user 40 (e.g., as shown in FIG. 4) to provide the user 40 an opportunity to obtain points (block 380). If points are successfully purchased or earned (block 382) a determination is performed to see if the user has enough points for the full subscription (block 384). If more points are needed (a “no” to block 384) the user is presented with other work items (block 380). Otherwise, the user's account is debited (block 374).

In another example aspect of the platform 20, users 40 have the ability to specify a user-assigned priority level for message senders (e.g., on a scale of 0-100), and the system controls presentation, notification, and/or automatic responses to messages from the senders based on the user-assigned priority level.

FIG. 8 schematically illustrates an example method 400 of delivering an electronic message. A user-assigned priority score is received from a user 40 for a sender (block 402), and notifications to the user for electronic messages from the sender are controlled based on the user-assigned priority score for the sender (block 404).

The messages could include any of the following, for example: direct messages within the platform 20, email messages (e.g., sent to an automatically generated email address for use in a single or limited number of communication threads), SMS messages, MMS messages, postings from a social media feed, postings from a blog feed, autonomous messages from an Internet-connected device or appliance, messages from an information feed 22 within the platform 20 (e.g., crowdsourced or organization feed), etc.

In one example, controlling notifications to the user 40 (block 404) includes providing a first type of notification to the user 40 for electronic messages from the sender if the user-assigned priority score is above a predefined threshold, and disabling the first type of notification for the user 40 for electronic messages from the sender if the user-assigned priority score is below the predefined threshold.

The first type of notification could be pop up alert (e.g., a pop up message for a computing device the user 40 is currently logged onto the platform 20 with) or a SMS message to a mobile device of the user 40, for example. Another type of first notification could include automatically opening the incoming message for the user 40. The user-assigned priority level could also be used for inbox sorting, such that incoming items from higher priority sources are given a greater weight and/or importance and are sorted at a higher level than items with a lower priority level (e.g., even if the lower priority items are more recent).

This granular control over notifications can prevent users 40 from being bombarded with notifications for every single incoming message, which is the case with many prior art messaging clients.

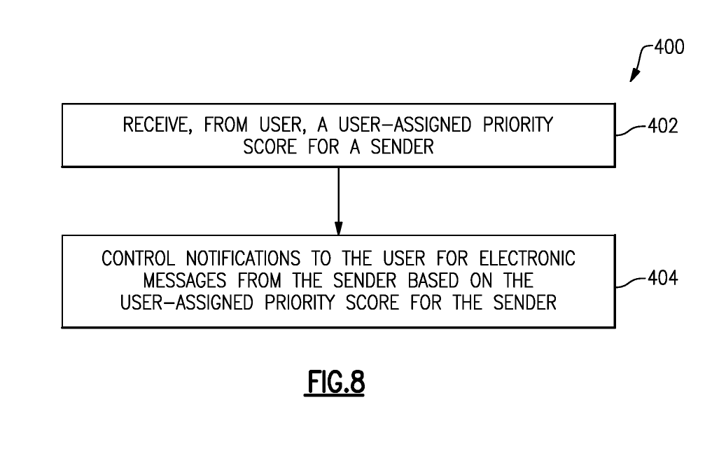

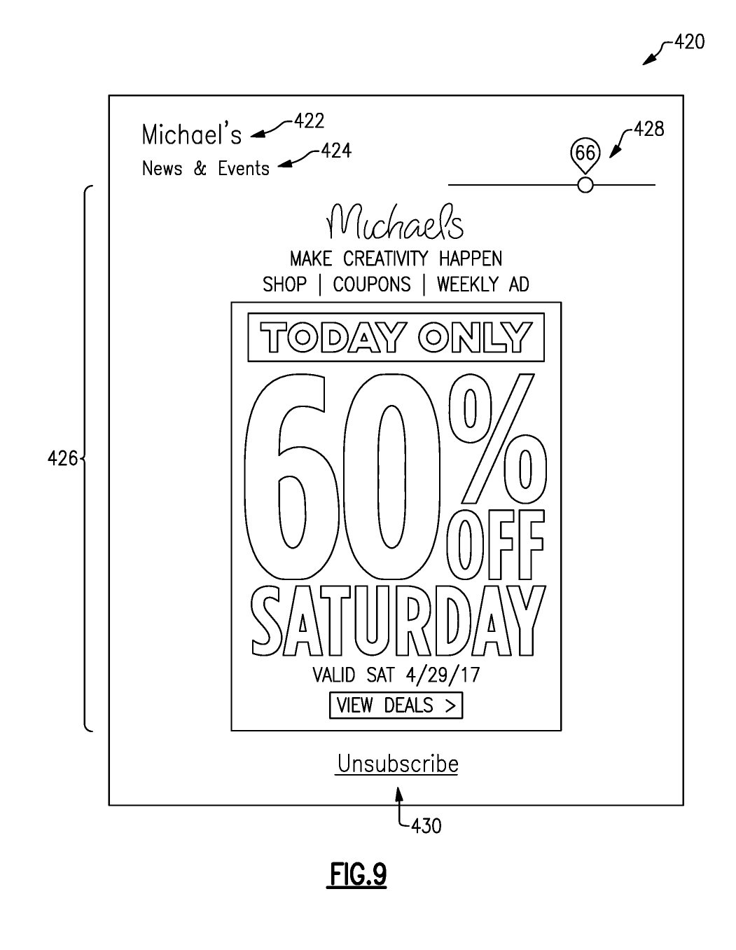

FIG. 9 illustrates an example message 420 received in a user's universal inbox 23. The message 420 includes a sender (in this case the company MICHAEL'S), and a category 424 of the message, which in the example of FIG. 9 is “News & Events.” Other example categories could include “Sales”, “Schedule”, “Investor Relations”, and “New Releases”, for example. The message 420 also includes a message body 426, and a slider user interface (UI) element 428 that can be used to specify a user-assigned priority level for the sender. In the example of FIG. 9 the priority level is 66, but can be adjusted by manipulating the slider UI element 428. Of course, different types of UI elements could be used in other embodiments (e.g., a freeform text entry box).

The message 420 may also include an unsubscribe link 430. If the message 420 is an in-platform message received from an information feed 22, the unsubscribe link 430 unsubscribes the user from that information feed 22. If the message 420 is addressed to a platform-generated email address and is sent from outside of the platform 20, then the unsubscribe link 430 disables the platform-generated email address, and prevents any additional messages addressed to the disabled email address from delivery to an inbox of the user. In a further example, the unsubscribe link 430 only prevents future delivery of messages from the sender 422, and lets other continue to use the email address.

User-assigned priority levels can also be used for handling invitations for electronic calendar events in the platform 20. FIG. 10 schematically illustrates an example method 450 of scheduling electronic calendar events. A user-assigned priority score is received from a user 40 for a sender (block 452). The platform 20 controls whether an incoming invitation sent from the sender to the user 40 for a calendar event is automatically accepted based on the user-assigned priority score (block 454).

In one example, the controlling of block 454 includes automatically accepting the invitation if the user-assigned priority score is above a first predefined threshold (e.g., 90), and prompting the user 40 to accept or reject the invitation if the user-assigned priority score is below a second predefined threshold that is lower than the first predefined threshold (e.g., 60). In one example, the providing of event reminders for the calendar event prior to a start time of the calendar event is also controlled based on the user-assigned priority score. If the user-assigned priority score is below a rejection threshold, the platform 20 automatically rejects the invitation in some examples.

In one example configuration, events from senders having a priority level over 80 are automatically accepted, and if below 80 then the user 40 is prompted to accept or reject the invitation. Also, if the priority level is below a rejection threshold (e.g., 10), the invitation is automatically rejected.

In one example, handling invitations for electronic calendar invitations includes controlling whether the invitation automatically appears on the user's calendar (even if not fully “accepted”) and/or controlling whether a tentative acceptance is provided. For example, if a priority level for the sender is above the second threshold (e.g., 60) and is below the first threshold (e.g., 90) then the platform 20 may transmit a conditional tentative acceptance to be followed by a firm decision—essentially “saving their space.” As part of the tentative acceptance, or even aside from the tentative acceptance, the platform 20 may display invitations on their corresponding days in a user's calendar as a visual aid to guide acceptance/non-acceptance.

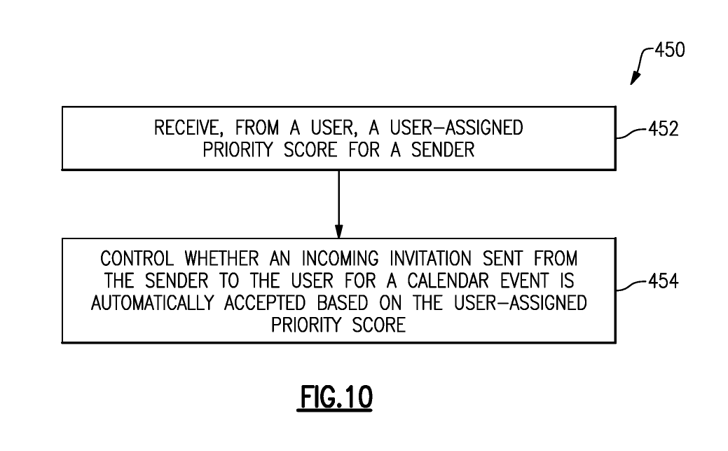

FIG. 11 illustrates an example event invitation 470 that includes a sender 472, a category 474, and message body 476 that describes an event. A prompt 477 lets a user accept or reject the invitation. A slider user interface element 478 is used to designate a user-assigned priority level for the sender. An unsubscribe link 480 gives the user 40 the choice to cease receiving any messages from the sender. In some examples, if the priority level is above the predefined threshold, then the prompt 477 is omitted because the invitation is automatically accepted.

In some examples, the platform 20 provides one or more of the following features in relation to events:
Event invitation templates
Smart invitations that are delivered based on recipient preference (e.g., preference for direct messages, email, etc.)
Event details (e.g., time, date, place) that are added to recipient calendars upon acceptance
RSVP count based on acceptance/decline
Memory sharing space for adding content such as posts, photos, videos, etc. after the event
Determining event priority based on a user-assigned priority level of the sender of the event
Selective hiding of recipients from each other based on sender and/or user preference
Auto-generation of a unique email address for the event (e.g., for receiving the RSVP responses)
Content privacy of the event invitation and/or the memory sharing space (e.g., all ages, adults only, etc.)
Detailed reporting and alerts to the organization about the event (e.g., number of accepting users, number users who have indicated interest in the event, work details about how the organization has promoted the event in the platform 20, etc.).

Here is a non-limiting example of how the platform 20 could use user-assigned priority levels for message and calendar invitation handling.
>90—automatically accept event invitations from the sender
>70—automatically open messages from sender in universal inbox
>60 and <90—automatically send a conditional tentative accept to be followed up by a firm decision of the event invitation
<60—prompt user to accept/reject calendar invitation
26-75—provide a website notification for messages from the sender
1-25—no message notification other than viewing message itself in inbox
0—unsubscribe from the sender/thread (and optionally also disable email address if message was addressed to an email address).

In one example feature, the platform 20 provides toast notifications in proximity to the slider user interface element 478 to indicate what one or more of the slider levels indicate (e.g., “0 will unsubscribe from a sender/thread”). Also, as discussed above, other non-slider user interface elements could be used besides sliders in some examples.

Of course, other point ranges and specific actions could be used, with the understanding that message notifications and/or event invitation handling (e.g., acceptance and/or reminders) are provided in whole or part based on the user-assigned priority level. In some examples, the notifications and/or event invitation handling are further based on other factors, such as user preferences and interests.

As discussed above, one aspect of the platform 20 is providing for the automatic generation of email addresses to facilitate communication with individuals outside of the platform 20, and also an email address disabling feature that occurs when a user 40 unsubscribes from a sender.

In one aspect of the platform 20, user-assigned priority levels are assigned on a per-thread level, such that a user 40 could have priority level A for interactions with mom, but priority level B for interactions with a group that includes mom and aunt. As a result, in some examples one may receive different notifications based on whether a message is coming from a person having a high priority level (e.g., above a predefined threshold) or a group which includes the person but has a lower priority level (e.g., below the predefined threshold).

FIG. 12 schematically illustrates an example method of facilitating communication between a user of the platform 20 and an external recipient. A request is received from a user 40 of the platform 20 to send a message to a recipient email address of a recipient (block 502). The platform 20 automatically generates a new email address for a communication thread between the user 40 and the recipient based on the request (block 504). The platform 20 sends the message to the recipient email address (block 506). The sent message includes the new email address as a sender email address and enables the recipient to contact the user 40 within the electronic communication platform 20 via email.

In another aspect of the platform 20, users 40 can also obtain unique email addresses upon request even if the users 40 are not presently trying to initiate communication with an email address outside of the platform 20, which could be useful for signing up for websites and/or newsletters, putting on business cards, giving to organizations, etc.

In another aspect of the platform 20, a determination is made of whether the recipient email address is registered to a user 40 of the platform 20. If the recipient email address is registered to a user 40 of the platform 20, the outgoing message is intercepted and re-routed for delivery as an in-platform message between the accounts of the user 40 and recipient instead of delivering the message to the recipient email address outside of the platform 20.

In a similar fashion, other types of messages, such as SMS and MMS messages, sent to addresses (e.g., phone numbers) that are registered in the platform can be intercepted and re-routed for delivery to the user 40 associated with the identified address.

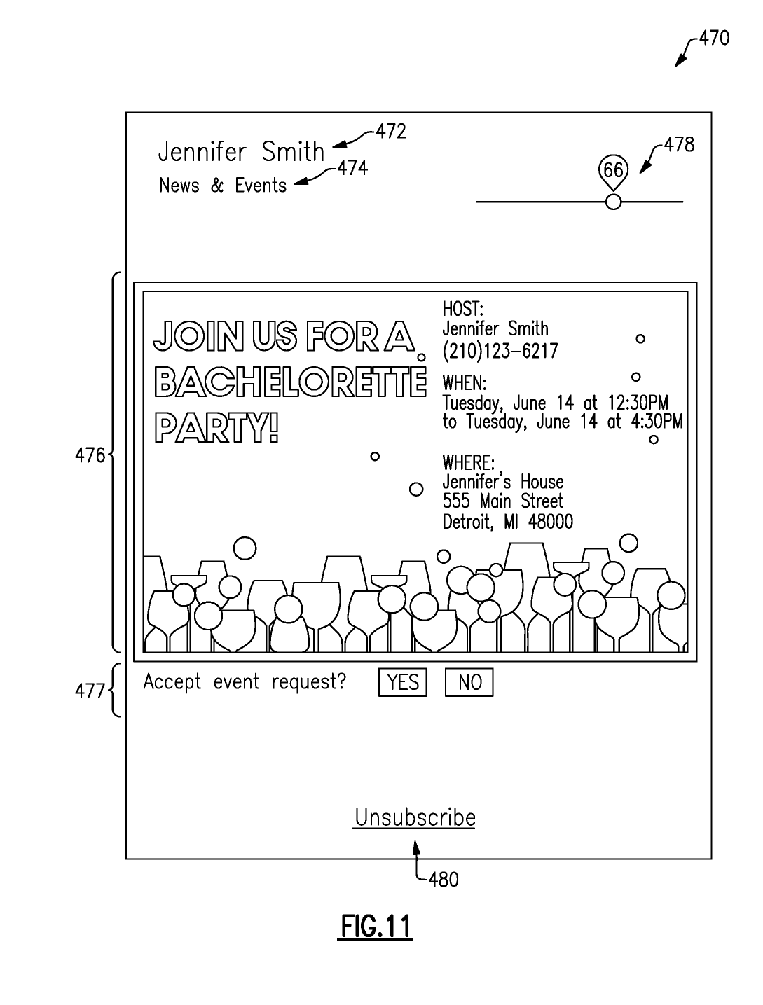

FIG. 13 schematically illustrates an example method 550 of facilitating communication within the platform 20 (or outside of the platform 20 in some examples). An unsubscribe interface element (e.g., element 430, 480) is provided to a user 40 in conjunction with the delivery of a message from a particular sender to the user 40 that is addressed to an email address of the user 40 (e.g., a platform-generated email address) (block 552). The platform 20 disables the email address in response to actuation of the unsubscribe UI element by the user 40, thereby preventing any additional messages addressed to the disabled email address from delivery to an inbox of the user (block 554).

In one example, the disabling of block 554 is a slow disable that disables delivery of messages to the recipient's inbox that are addressed to the disabled email address but still delivers messages addressed to the disabled email address to a trash bin folder of the user for a period of time (e.g., a number of months) before fully disabling the email address. In a further example, the disabling of block 554 is a complete disabling that prevents delivery of any additional messages addressed to the disabled email address to the inbox and to the trash bin folder for the user.

In one example, the unsubscribe UI element only blocks delivery of additional messages from the sending party, such that other senders may continue to use the email address.

In one example, the presenting of the unsubscribe UI element (block 552) includes displaying the unsubscribe UI element to the user in proximity to contents of the message, even if the original message lacks an unsubscribe hyperlink. Thus, in some examples the platform 20 provides an unsubscribe UI element whether or not one is already present in the original message.

In another aspect of the platform, unsubscribe features are also provided for non-email messages, such as receipt of information feed 22 messages and/or direct messages within the platform 20. In one example, if a user 40 unsubscribes from a publication (or communication thread with a direct message sender), the platform 20 behaves differently depending on the user-assigned priority level of the sender. In one example, if the user-assigned priority level is above a threshold, a first set of operations are performed such as prompting the user 40 to confirm whether they really want to unsubscribe and/or continuing to deliver messages from the information feed (or direct message sender) to a trash bin folder of the user 40, or maintaining an archive of the undelivered messages outside of the trash bin such that the messages can be delivered if the user re-subscribes. If the user-assigned priority level is below the threshold, then the prompting, trash bin delivery, and/or message archiving may be omitted.

Similarly, the platform 20 may behave differently when a user 40 lacks sufficient points to continue a subscription to an information feed 22 based on the priority level of the sender. If the user-assigned priority level is above a threshold and the user lacks points for delivery of messages, the platform 20 may perform a first set of operations such as archiving undelivered messages from the information feed 22 for a time period until the user 40 provides the needed funds. If the user-assigned priority level is below the threshold, such archiving may be omitted. The platform 20 may handle direct messages in a similar fashion in some examples.

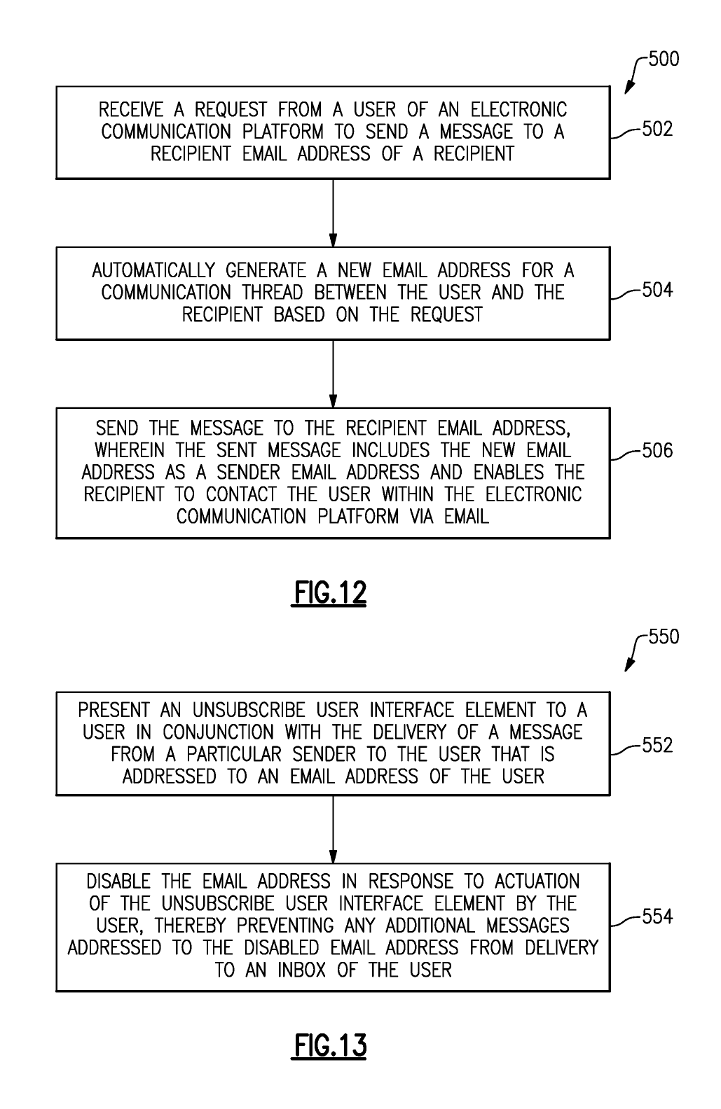

FIG. 14 schematically illustrates an example method 600 of facilitating communication within the platform 20. An advertisement message is received from an organization 44 (block 602). A plurality of users 40 of the platform 20 are identified as recipients for the message (block 604). For each identified user 40, the advertisement message is delivered without an indicator that the message is an advertisement if the user 40 has subscribed to the organization within the platform 20 (block 606), and is delivered with an indicator that the message is an advertisement if the user 40 has not subscribed to the organization 44 within the platform 20 (block 608).

In some examples, the way in the message is delivered (e.g., with or without an advertisement indicator) affects how much and/or whether the organization 44 is charged for delivery of the message. In one example the advertisement messages and non-advertisement messages are all delivered to the same inbox, and the advertisement indicator includes an icon, color, or some other emphasis to distinguish the advertisement message. In another example, items delivered as advertisements are delivered to a separate advertisement inbox, and the advertising indicator is the name or styling of the advertisement inbox.

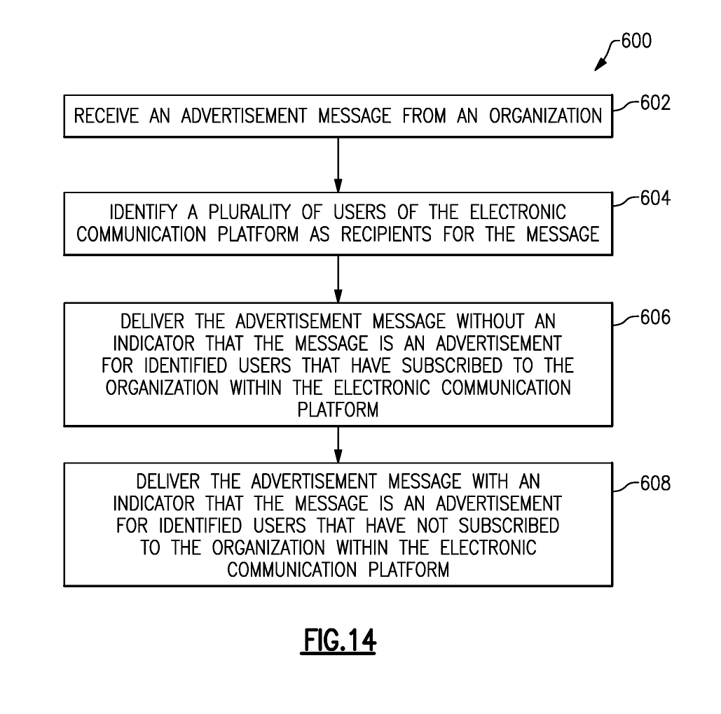

FIG. 15 illustrates an example landing page 650 for an organization 44 that promotes the organization 44 and its offerings (e.g., specials, promotions, deals, available products and/or services, etc.). The landing page 650 includes an organization name 652, contact information 654 (which includes a map, address, phone number, and URL), social media links 656, and available publications 658A-D. Each available publication 658 corresponds to an information feed 22 covering a given topic (e.g., “tips and tricks,” “security notifications,” etc.), and includes a description indicating a typical frequency of publication (“2-5 events/week” in each example in FIG. 15), a popularity of the publication (“100 subscribers” in the feeds 658 in FIG. 15), and a topic. Although not shown in FIG. 15, in some examples photo sharing for an organization could be provided on or through its landing page 650. Also, although not shown in FIG. 15, an organization 44 may include a “subscribe to all” user interface element on their landing page to provide a convenient way to subscribe to all of their publications.

Referring again to FIG. 1, users 40 interact with the platform 20 using computing devices 42, and organizations 44 interact with the platform 20 using computing devices 46. The computing devices 42, 46 could include smartphones, tablets, laptops, desktop computers, embedded computing devices (e.g., in a vehicle), or any other type of computing device. One or more servers are also used to support the platform 20.

FIG. 16 schematically illustrates an example computing device 700 that may be used to implement the computing devices 42, the computing devices 46, and/or the one or more servers implementing the platform 20.

The computing device 700 includes a processor 702, memory 704, and a communication interface 706. The processor 702 can be a custom made or commercially available processor, a central processing unit (CPU), an auxiliary processor among several processors, a semiconductor-based microprocessor (in the form of a microchip or chip set), or generally any device for executing software instructions.

The memory 704 is a computer-readable storage medium and may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.), for example. Moreover, the memory 704 may incorporate electronic, magnetic, optical, and/or other types of storage media. The memory 704 can also have a distributed architecture, where various components are situated remotely from one another, but can be accessed by the processor 702.

The communication interface 706 can include, for example but not limited to, one or more buses and/or other wired or wireless connections. The communication interface 706 may have additional elements, which are omitted for simplicity, such as controllers, buffers (caches), drivers, repeaters, and receivers to enable communications. Further, the communication interface 706 may include address, control, and/or data connections to enable appropriate communications among the aforementioned components.

When the computing device 700 is in operation, the processor 702 can be configured to execute software stored within the memory 704, to communicate data to and from the memory 704, and to generally control operations of the computing device 700 pursuant to the software. Software in memory 704, in whole or in part, is read by the processor 702, perhaps buffered within the processor 702, and then executed. The software may be used for interacting with the platform 20 (e.g., in the case of computing devices 42 and 46) and/or for supporting the platform 20 (e.g., in the case of a server running one or more elements of the platform 20). In some examples, the memory 704 includes one or more computer program products that when executed by the computing device 700, configured the computing device 700 to implement one or any combination of the methods discussed herein.

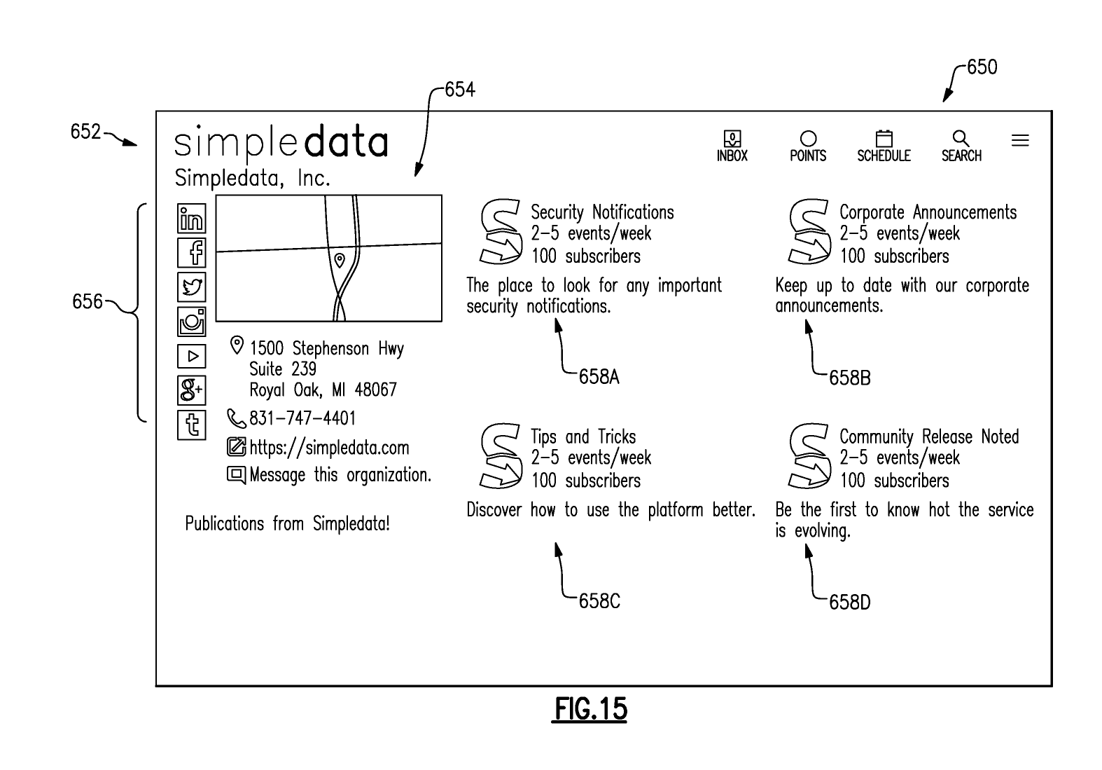

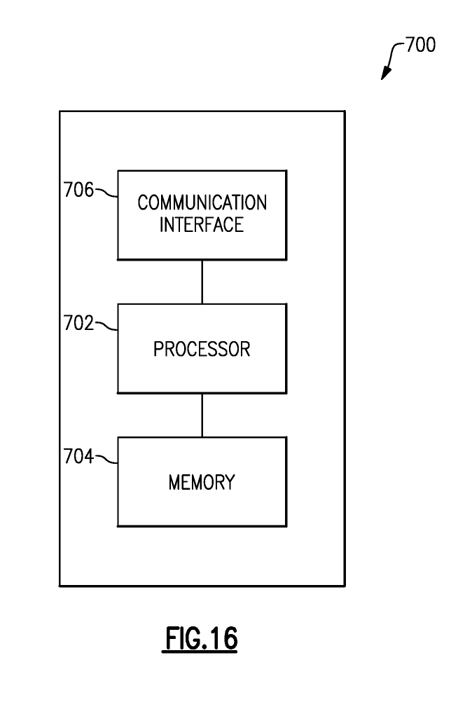

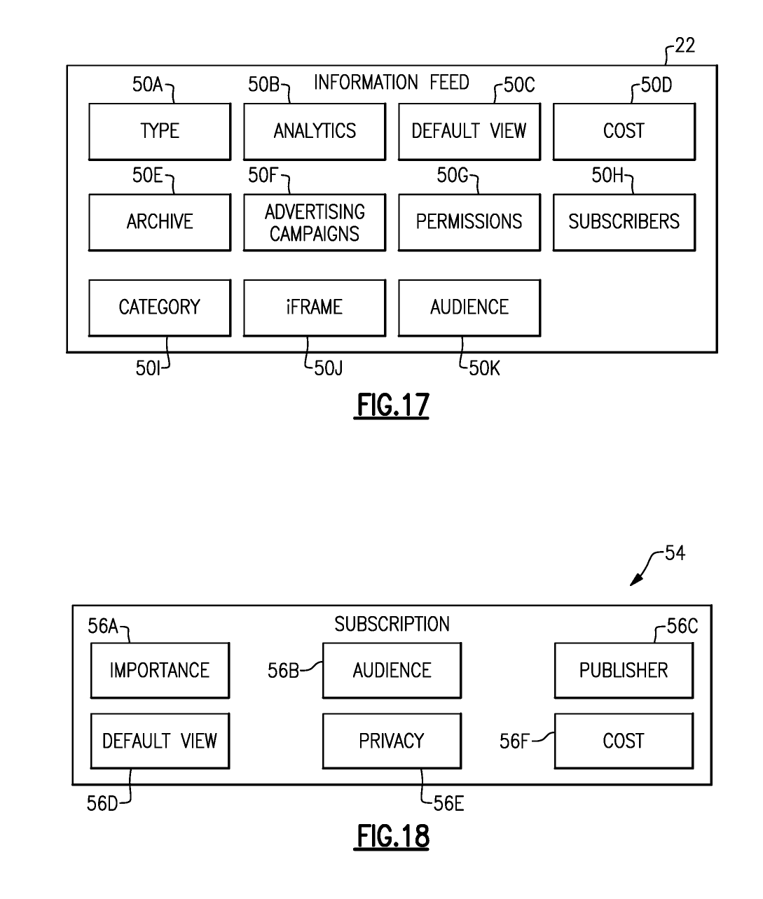

FIGS. 17-23, which illustrate various aspects of the platform 20 in greater detail, will now be discussed.

FIG. 17 illustrates example aspects of an information feed 22 in greater detail. In the example of FIG. 17, a plurality of attributes 50A-K are shown. The information feed 22 includes a type 50A, such as those discussed above (e.g., email, direct messages, SMS/MMS, social media feeds, IoT messages, etc.). Analytics 50B stores statistics and/or metrics of the information feed 22 which may indicate, for example, an extent to which items published in the information feed 22 are actually viewed by users 40, and/or acted upon by users 40. A default view 50C indicates a default mode of presentation for the information feed 22, such as a blog view, a calendar view, etc.

A cost 50D of the information feed 22 indicates how many points are charged to users 40 to subscribe to the feed. Archive 50E stores a repository of messages from the information feed 22. Advertising campaigns 50F may optionally be used to provide posts from the information feed 22 to non-subscribers in the platform 20 as work items 24. Permissions 50G indicates which users 40 are administrators of the information feed 22. Subscribers 50H indicates which users 40 subscribe to receive the information feed 22 in their respective inboxes. Category 50I provides a description of the content of the information feed 22 (e.g., “News and Events”). An iFrame 50J attribute can be used to enable/disable and/or obtain HTML code for reading the information feed 22 outside of the platform 20. Audience 50K indicates an age-appropriateness of the information feed, such as, “all ages”, “adults only”, “private”, etc.

Of course it is understood that this is only an example, and that additional or elements may be utilized for a given information feed 22. For example, if an information feed is provided for an Internet connected device or appliance (e.g., an IoT device) the advertising campaign 50F and/or iFrame 50J attributes may not be utilized.

Users 40 subscribe to information feeds 22 with subscriptions 54. FIG. 18 illustrates a plurality of example attributes 56A-H of a subscription 54. Importance 56A indicates a user-assigned priority level for a given information feed 22. In one example, this includes a score between 0-100. In some examples, the user-assigned importance 56A may be indicated through a slider UI element (similar to the user-assigned priority level discussed above in connection with slider UI elements 428, 478). Audience 56B indicates a user appropriateness of the content of the feed (e.g., “all ages”, “adults only”, “private”, etc.)

Publisher 56C indicates a source of the information feed 22, such as an indication of whether the information feed 22 is provided by a particular organization 44 or is provided by one or more users 40. Default view 56D indicates a default view of how the user 40 wishes to view the information feed 22 at issue. A privacy 56E indicates whether the subscription corresponds to a public information feed 22 (e.g., of an organization) or a private feed (e.g., a user's IoT device that they may not wish to share with others). Cost 56F indicates how many points are required to subscribe to the information feed 22.

Referring again to archive 50E, in some examples publishers are able to decide whether content from a given information feed 22 is accessible in an archive. It may be desirable for an organization 44 to archive certain types of content, such as that about product lines or product releases, but in some instances it may be desirable to not archive certain content such as promotions or sales, as recipients may become less willing to pay non-sale prices upon learning of past promotional pricing.

In some examples, a publisher is permitted to provide its information feed 22 for free both for itself and to its first n subscribers, and once that threshold quantity of n users has been reached, additional users beyond the n users will be charged a fee to subscribe to the subscription until the publisher upgrades from the “free plan” to a paid plan at which their information feed 22 is no longer free to the organization 44. This incentivizes the organization 44 to upgrade, so as to not risk alienating new users who may otherwise be interested in subscribing to the information feed 22.

While some organizations 44 may run their own information feeds 22, other may have crowdsourced feeds whose posts are provided by users 40 that may have no formal association with the organization 44. This may be particularly useful for organizations 44 who have not yet formally created an account with the platform 20. The platform 20 may nevertheless include respective landing pages 650 (see, e.g., FIG. 15) for a plurality of organizations 44 even though those organizations 44 do not have accounts with the platform 20.

The platform 20 includes a peer review mechanism for reviewing crowdsourced posting to a given information feed 22, to provide some degree of quality control, and avoid the sharing of low quality and/or inappropriate postings. As such, in some examples users 40 must pay to submit a post to a crowdsourced information feed 22 and if their posting is deemed to be sufficiently high quality they may receive a favorable feedback rating. In one example, the submission fee for posting to a crowdsourced information feed may be may be waived once a user 40 achieves a threshold reputation level.

Also, users 40 that submit content to a crowdsourced information feed 22 may optionally share in the subscription fees for that information feed 22 from other users 40 for a given time period. For example, if it costs x points to subscribe to an information feed 22 on a monthly basis, those x points may be allocated between the users 40 that create posts and that moderate posts for the information feed 22. As the number of subscribes for a given feed grows, this can provide a strong incentive to promptly moderate content and to provide high quality content.

Referring now to FIG. 19, attributes of work items 24 will now be discussed. Each user 40 can view work items 24 in a work queue (e.g., the advertising inbox 25). “Work” within the platform 20 may take a variety of forms. For example, crowdsourced offers 62A may be provided whereby users 40 have an opportunity to provide posts to crowdsourced information feeds 22. Advertisement offers 62B provide another way of earning points, through tasks associated with a given organization 44 such as viewing advertisement videos, taking market surveys, rating branding and/or logo ideas, etc.

Publisher directed offers 62C provide organizations 44 with an opportunity to outsource tasks to users 40 of the platform 20 that can be performed on a distributed basis by the users 40 as mini-contracts. For example, assume that an organization 44 has a large number of images and desires to know one ones of those images depict a certain item. These organizations 44 may reward users 40 with points in the platform 20 for viewing batches of the images and identifying which ones of the images depict the item. Other examples of publisher directed offers could include having users 40 write content for a website, having users 40 teach a language online (e.g., English), having users 40 translate text, having users 40 perform data entry, and having users 40 create templates to be used for messages and/or event invitations within the platform 20.

An offer algorithm 62D identifies work opportunities for a given user 40 based on the user's interests and/or demographic information. For example, if a user 40 is in a certain age bracket, and of a certain socio-economic status that is of interest to an offeror (such as an organization 44 or even a user 40), work offers related to that offeror may be provided to that user 40, whereas other users 40 not having those characteristics may not be provided with the same work opportunities.

An offer amount 62E indicates an amount of in-platform points offered for completing a given offer. An offer duration 62F indicates a period of time for which the offer is to be provided. This could be useful, for example, if there are advertisements directed towards a time sensitive or date-based product or event, and it would not be desirable to continue advertising for that product or event after that date. Offer criteria 62G indicates the specific user attributes desired by publishers for users 40 to accept the offer (e.g., age, interests, ethnicity, income, etc.).

Referring now to FIG. 20, a points module 70 is shown which includes a transaction history 72A for a given user 40, which indicates their history of accumulating and spending points. As discussed above points can be accumulated by either purchasing them, or by performing work tasks within the platform 20. Additionally, points can be spent within the platform on a variety of actions, such as for sending messages and/or submitting crowdsourced content and/or subscribing to information feeds 22. In some examples points can also be spent on third party merchandise and/or services (e.g., gift cards). The points module 70 also includes a record of points purchased 72B, a record of points spent 72C, and a record of points earned 72D.

Some examples of ways in which users 40 can earn points in the platform 20 include:
Watching and/or interacting with an advertisement (e.g., opportunity from work queue/advertising inbox 25)
Answering a survey (e.g., about an advertisement) (e.g., opportunity from work queue/advertising inbox 25)
Providing quality assurance for a publication (e.g., opportunity from work queue/advertising inbox 25)
Performing work for the platform 20 (e.g., opportunity from work queue/advertising inbox 25)
Performing work for any organization 44 on mini-contracts (publisher-directed offers) (e.g., opportunity from work queue/advertising inbox 25)
Submitting content to a crowdsourced information feed 22 (if the submission is deemed to be of an acceptable quality)
Receiving a donation from other users 40 that enjoy the creator's posting (e.g., if other users 40 enjoy one of your posts they can donate some points to you)
Providing additional profile information (e.g., a drip registration in which users are prompted to provide additional profile information beyond what has already been provided).

Some examples of ways in which users can spend points in the platform 20 include:
Purchasing a gift card, cashing out earned points for actual currency (e.g., US dollars), or similar
Sending a message to anyone without a platform 20 account (e.g., an external email address). In some examples such a message by default includes an invitation to join the platform 20.
Having the platform 20 generate a new unique email address for a communication thread
Providing a content submission to a crowdsourced information feed 22 (initial submission fee, potentially earned back if submission is deemed to be of acceptable quality)
Subscribing to a publication that is not free
Donating to content providers as a tip (e.g., if a user 40 enjoyed a post from a publisher they the user 40 could make a donation to the publisher)
Submitting a work item to the platform 20 for completion by other users 40 (e.g., placing an advertisement, survey, etc.)
Correctly flagging content as violating rules of the platform 20 (as a corollary to this, users may be charged points and/or have their reputation adjusted for intentionally incorrectly flagging content)
Delivering advertising messages to the advertising inbox of non-subscribers
Publishers paying for a quantity of information feeds 22 over a threshold
Publishers paying for more than a predefined number of administrators
Synching one's platform 20 calendar with their external calendar(s)
Publishing events the platform 20 search database 32 (e.g., a happy hour event at a restaurant that you want others in proximity to you to be able to find when searching through a geolocation feature)
Spending points as microtransaction currency inside or outside of the platform 20 (e.g., for microtransactions that cost a fraction of a penny on an external website, such as for reading a news article).

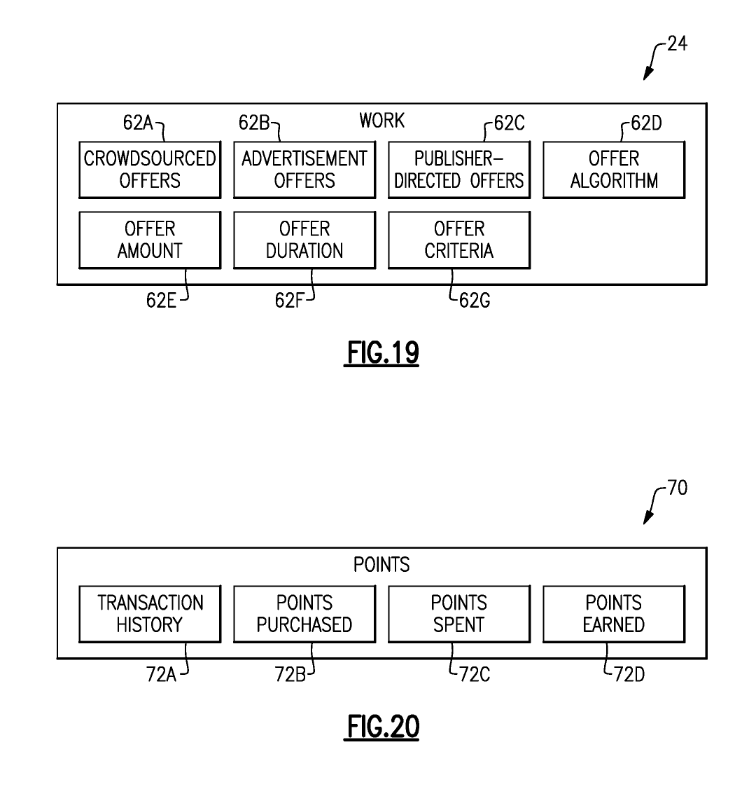

FIG. 21 schematically illustrates aspects of a user account 26 for a given user 40. The user account 26 includes a universal inbox 82A which the user 40 can use to receive message from a plurality of sources, such as in-platform messages, email messages from an outside party, SMS and/or MMS messages, and messages from information feeds 22. The user account 26 also includes a record of information feed 22 subscriptions 82B, current and/or historical point data 82C for the user 40, and a history of work items 82D performed by the user 40 and/or attributes of work that is presented to the user 40 on an ongoing basis.

The user account 26 also includes a record of calendar events 82E which includes events having a defined date and start time that the user 40 has received. The user account 26 also includes a publishers attribute 82F that indicates information feeds 22 the given user 40 is an administrator for. For example a given user 40 could be an administrator for the in-platform information feeds 22 of a plurality of different publishers (crowdsourced or non-crowdsourced) or for their own information feeds 22. The user account 26 also includes a usage history 82G which indicates how the user 40 has used the platform 20, similar to a web browsing history.

A preferences property 82H can be used for a number of items, such as whether multifactor authentication is preferred, preferred formats for viewing content in the platform 20, etc. The user account 26 also has a reputation 82I of the user 40 that is based on peer user 40 and/or organization 44 feedback, and provides a rating of the user's interactions with the platform 20. This can includes the quality of messages the user 40 submits within the platform 40 (such as whether their submissions to a crowdsourced publication are high or low quality), a quality of the work performed by the user 40 within the platform 20, and/or whether the user correctly or abusively flags content in the platform 20 as being inappropriate.

The user account 26 also includes demographic data 82J of the user 40 (e.g., age, education level, geographic location, interests, approximate income level, ethnicity, gender, education level, etc.), and a list of the user's devices 82K that are authenticated with the user's account 26 in the platform 20. A friends list 82L is an in-platform contact list of other users that the user 40 has interacted with, and/or can send messages with.

In some examples the platform 20 omits a user lookup feature that is otherwise present in other communication platforms and social networks, in order to maintain user privacy (e.g., no lookup by name or school or city). By preventing users 40 from searching for each other, the privacy of all users 40 can be maintained. However, if a user 40 sends a message to an external email address that is known to the user 40, and that email address is linked to the account of another user 40 of the platform 20, then those two users 40 are linked as friends in the friends list 82 of their respective user accounts 26. The user account 26 also includes a social media verification 82M component, which could be used in some examples to authenticate the user 40 for receiving their external social media feeds and/or for user validation and assurance via the user's 40 other social media accounts (e.g., certifying that the user 40 is who they say they are on one or more social networks other than the platform 20).

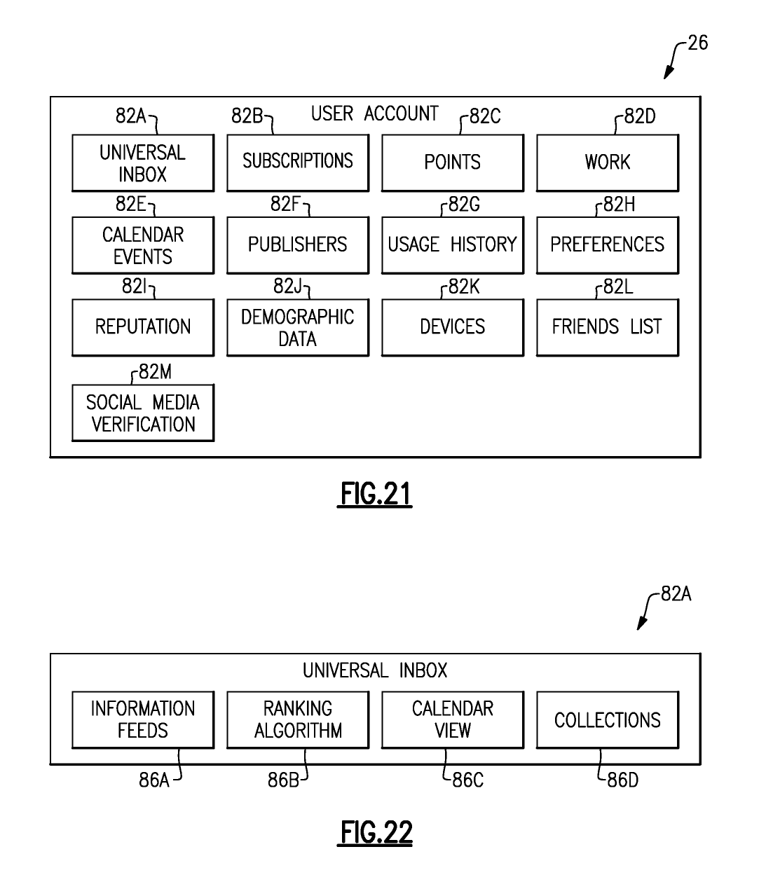

FIG. 22 schematically illustrates the universal inbox 82A of FIG. 21 for a given user 40, which is an example implementation of the universal inbox 23 of FIG. 1. The universal inbox 82A includes one or more information feeds 86A that the user 40 subscribes to 86A. The universal inbox 82A includes a ranking algorithm 86B which determines an order of presentation of items within the universal inbox 82A. The ranking algorithm may perform its sorting based on a number of factors, such as which previously delivered messages remain unread, quantity of messages that are unread, whether a message from an advertiser is promoted, the user-assigned priority level of the sender/thread, etc.

Universal inbox 82A also includes a calendar view 86C where events having a defined start date and time can be viewed. A collections 86D attribute categorizes the various subscriptions of a given user 40. For example this may be done by subject matter such that the collections include tags, which can be used for filtering messages. Consider, for example, that a given user 40 is interested in motorcycles and subscribes to a number of motorcycle publications, if it is determined that an interest in motorcycle publications increases or decreases, the ranking algorithm 86B can adjust its sorting of inbox items accordingly based on which information feeds 22 correspond to that interest area.

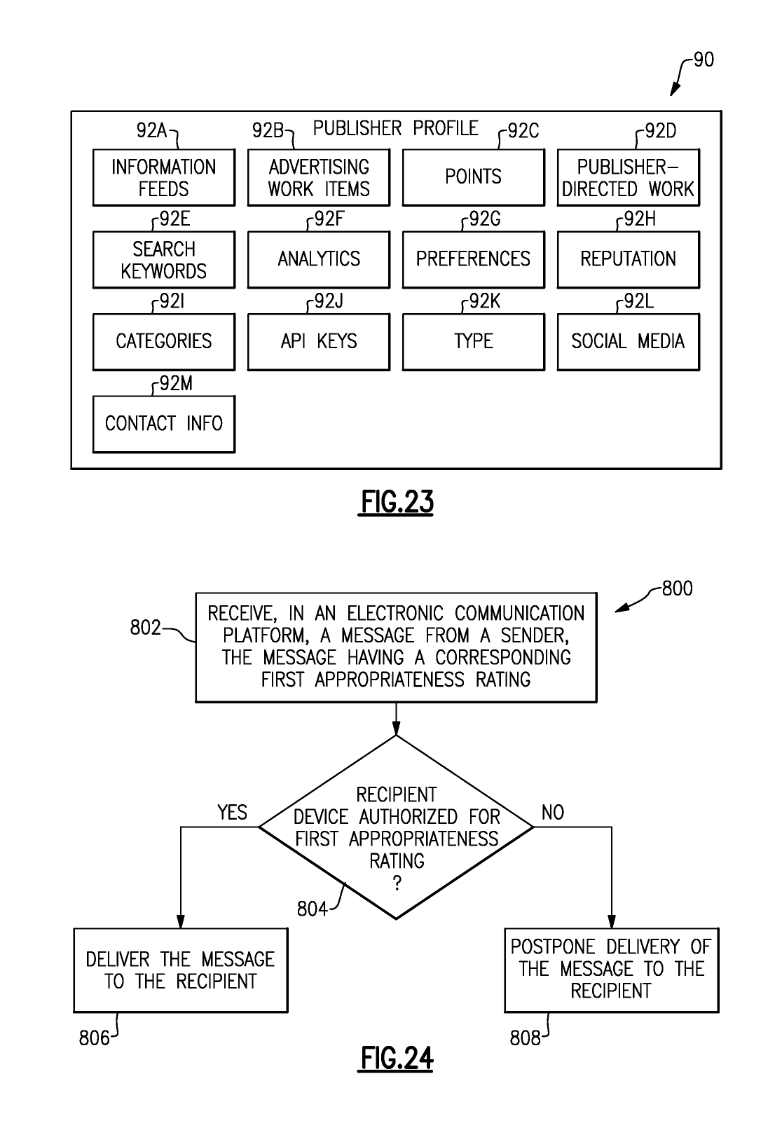

FIG. 23 schematically illustrates a publisher profile 90 and its various attributes. The publisher profile 90 includes a list 92A of information feeds 22 that the publisher provides. In the platform 20, a “publisher” can be an individual user 40, a group of users 40 (e.g., in a crowdsourced information feed), or an organization 44, for example. A given publisher may provide one or a plurality of information feeds 22. As an example, consider a local business that wishes to have a first publication for upcoming in-store events, a second publication for new product lines, a third publication for existing product lines, and a fourth publication for specials and promotions. The list 92A of information feeds tracks these various publications of the publisher. Additionally, a user 40 may have a plurality of publisher profiles 90 if they provide more than one information feed 22.

A list of advertising work items 92B indicates which work items 24 are being offered by the publisher in the platform 20. For example, the publisher may have surveys, advertisements, videos to watch, etc. as work items 24 being held out to users 40 as a way to earn points. Points attribute 92C indicates how many points the publisher currently possesses. Publisher-directed work attribute 92D indicates which work items 24 are currently offered by the publisher in a potentially non-advertising context. An example of this could be the image identification described above, where the publisher seeks to effectively outsource tasks to users 40.

Search keywords 92E indicate descriptive terms that can be used for describing the given publisher, and for finding that publisher within the platform 20. An analytics module 92F provides platform 20 usage information to the publisher, such as how many times their various postings have been viewed, how many subscribers they have, etc. A preferences attribute 92G indicates preferences of a given publisher, such as a target audience, a preferred page layout for publications, etc. A reputation attribute 92H indicates a reputation of the publisher within the platform 20. The reputation 92H could be indicative of the quality level of messages disseminated by the publisher within the platform 20. For example, if the publisher provides a publication of their products but it is poorly presented or poorly written, or is conversely very well put together, the reputation 92H would reflect that. The reputation 92H could be used to control how much the publisher is charged for its publications. For example increasing a posting fee to a publication for a poorly performing publisher could disincentivize future poor quality posts from the publisher, and could prevent the publisher from devolving into using spam techniques in the platform 20.

A categories 92I attribute could include a taxonomy for the publisher, indicating within a hierarchy of classifications how the publisher characterizes itself or how others characterize the publisher. For example, if a publisher is an acoustic guitar company, their categories 92I attribute may indicate “Musical Instruments & Gear>Guitars & Basses>Acoustic Guitars.”

API keys 92J could in some examples be used to allow the publisher to post to the platform 20 from external software, such as internal corporate software used for other purposes (e.g., CRM or other enterprise software). The type 92K indicates what type of entity the publisher is (e.g., individual user 40, group of users 40, organization 44, and possibly the type of organization such as company, charity, religious, governmental, etc.). A social media attribute 92L indicates the various social media accounts of the publisher which can be linked to from the publishers landing page. A “contact information” attribute 92M stores contact information for the organization 44, such as their address, website URL, phone number, hours of operation, etc.

In another aspect of the platform 20, delivery of messages is controlled based on an appropriateness rating for the message (e.g., “general audience”, “adults only”, “private”). Of course, these are only example appropriateness ratings, and it is understood that other appropriateness ratings could be used in addition or as alternatives to these.

FIG. 24 schematically illustrates an example method 800 of delivering electronic messages. A message is received in the platform 20 from a sender, the message having a corresponding first appropriateness rating (block 802). A determination is made of whether a message recipient is using a first device which is authorized to receive messages in the platform 20 having the first appropriateness rating, or is using a second device that is unauthorized to receive messages in the platform 20 having the first appropriateness rating (block 804). If the recipient is currently using the first device to access the platform 20, and the first device is authorized to receive messages having the first appropriateness rating, then the message is delivered to the recipient (block 806). However, if the recipient is currently using the second device to access the electronic platform, and the second device is not authorized to receive messages having the first appropriateness rating, delivery is postponed (block 808).

As an example of the method 800, consider that a user 40 may wish to only receive “general audience” material when they are accessing the platform at a first location, such as at a place of work. They may designate their work computer as being authorized only for the “general audience” appropriateness level in the platform 20. The user 40 may find it acceptable to receive “adults only” or “private” content at a second location, such as their home. In one example, if a message having an “adults only” appropriateness rating is sent to the user 40 in the platform 20 while the user 40 is accessing the platform using their work computer, delivery of the message is postponed until the user 40 accesses the platform 40 using the second device. However, if another message is sent to the user that has an appropriateness rating of “general audience” then the message is delivered to the user 40 no matter what device they are currently using.

This could be useful, for example, if a user 40 subscribes to multiple information feeds 22, some of which are appropriate for all audiences, and some of which are appropriate for only adult audiences. Using the configuration above, the user 40 could receive messages from the “all audiences” information feeds 22 while on the work device, but only receive the “adult only” or “private” information fees 22 while on their home device.

In one example aspect, the system 20 allows users to override appropriateness ratings for certain senders. For example, if a sender has a known history of sending adult content, the recipient can designate all content originating from that sender as “adults only” or “private” even if the sender designates it as “general audience”, to guard against the possibility that undesired content may be received onto the recipient's work device. This override feature could be used for information feeds 22 and messages between users 40, for example. This override feature could also be useful if the sender and recipient have different views as to what qualifies for the various appropriateness levels (e.g., what is “general audience” to one group of users may be considered “adults only” to another group of users).

The various features of the platform 20 discussed above provide a number of benefits to both users 40 and organizations 44. Users 40 get to maintain their privacy, avoid spam, and receive relevant and targeted content very conveniently. Publishers get to target relevant users 40, ensure actual engagement with their materials (otherwise no points are earned by the user in some examples), and also have access to valuable analytics information.

The platform 20 strongly disincentivizes the bad behaviors that have afflicted previous content providers and social networks. The platform 20 disincentivizes spamming because message transmissions require spending points having a monetary value. Trolling would also be greatly reduced through the peer-review process for crowdsourced publications in the platform 20. Additionally, poor quality moderation work would be disincentivized, and poor quality crowdsourced content would be disincentivized, whereas high quality publications and events would be incentivized.

Although the features discussed above have largely been discussed in the context of the platform 20, it is understood that some features, such as those associated with the user-assigned priority level (e.g., message notifications, inbox sorting, event auto-acceptance) could also be incorporated outside the platform in a standard email client.

Also, although example embodiments have been disclosed, a worker of ordinary skill in this art would recognize that certain modifications would come within the scope of the claims. For that reason, the following claims should be studied to determine their true scope and content.

What is claimed is:

1. A method of delivering an electronic message, comprising:
receiving, from a user, a user-assigned priority score for a sender; and
controlling notifications to the user for electronic messages from the sender based on the user-assigned priority score for the sender.

2. The method of claim 1, wherein the electronic messages from the sender comprise one or more of:
direct messages within an electronic communication platform;
email messages;
Short Message Service (SMS) messages;
Multimedia Messaging Service (MMS) messages;
postings from a social media feed;
postings from a blog feed;
autonomous messages from an Internet-connected device or appliance.

3. The method of claim 1, wherein said controlling notifications to the user comprises:
providing a first type of notification to the user for electronic messages from the sender if the user-assigned priority score is above a predefined threshold; and
disabling the first type of notification for the user for electronic messages from the sender if the user-assigned priority score is below the predefined threshold.

4. The method of claim 3, wherein the electronic messages comprise invitations for calendar events, and the notifications comprise reminders provided before start times of the calendar events.

5. The method of claim 3, wherein the first type of notification comprises a pop up alert or short message service (SMS) message.

6. The method of claim 1, comprising:
providing a first type of notification to the user for electronic messages from the sender if the user-assigned priority score is above a predefined threshold; and
providing a different, second type of notification to the user for electronic messages from the sender if the user-assigned priority score is below the predefined threshold.

7. The method of claim 1, wherein said receiving a user-assigned priority score for the sender comprises receiving the score from a slider user interface element.

8. The method of claim 1:
wherein said receiving a user-assigned priority score for the sender comprises:
receiving, from the user, a first user-assigned priority score for a first communication thread that includes the user and sender; and
receiving, from the user, a second user-assigned priority score for a second communication thread that includes the user, the sender, and at least one additional party, wherein the first and second user-assigned priority scores are different; and
wherein said controlling notifications to the user for electronic messages from the sender comprises:
controlling notifications for messages in the first communication thread based on the first user-assigned priority score; and
controlling notifications for messages in the second communication thread based on the second user-assigned priority score.

9. The method of claim 1, comprising controlling whether an incoming calendar invitation sent from the sender to the user is automatically accepted based on the user-assigned priority score.

10. A method of scheduling electronic calendar events, comprising:
receiving, from a user, a user-assigned priority score for a sender; and
controlling whether an incoming invitation sent from the sender to the user for a calendar event is automatically accepted based on the user-assigned priority score.

11. The method of claim 10, wherein said controlling whether the incoming calendar invitation sent from the sender to the user is automatically accepted comprises:
automatically accepting the invitation if the user-assigned priority score is above a first predefined threshold; and
prompting the user to accept or reject the invitation if the user-assigned priority score is below a second predefined threshold that is lower than the first predefined threshold.

12. The method of claim 11, comprising:
automatically transmitting a tentative acceptance of the invitation if the user-assigned priority score has a value between the first and second predefined thresholds.

13. The method of claim 10, comprising, after the invitation has been accepted:
controlling the provision of reminders to the user for the calendar event prior to a start time of the calendar event based on the user-assigned priority score.

14. A method of facilitating communication within an electronic communication platform, comprising:
awarding credits to users for completion of work tasks initiated in an electronic communication platform; and
deducting credits from users for sending messages within the electronic communication platform, subscribing to feeds in the electronic communication platform, or both.

15. The method of claim 14, wherein the work tasks comprise at least one of viewing advertisements, taking surveys, answering questionnaires, providing additional profile information in a drip registration, authoring website content, translating text, performing data entry, creating message templates, and creating event invitation templates.

16. The method of claim 14, wherein the work tasks comprise reviewing user-submitted content for approval prior to delivery of the user-submitted content to a group of recipients.

17. The method of claim 16, wherein the user-submitted content is crowdsourced content that describes an aspect of an organization.

18. The method of claim 16, wherein said deducting credits from users for sending messages within the electronic communication platform is performed based on a feedback score of the user that is aggregated from a plurality of peer reviews from users of the electronic communication platform.

19. A method of facilitating communication between a user of an electronic communication platform and an external recipient, comprising:
receiving a request from a user of an electronic communication platform to send a message to a recipient email address of a recipient;
automatically generating a new email address for a communication thread between the user and the recipient based on the request; and
sending the message to the recipient email address, wherein the sent message includes the new email address as a sender email address and enables the recipient to contact the user within the electronic communication platform via email.

20. The method of claim 19, comprising:
determining if the recipient email address is registered to a user of the electronic communication platform; and
if the recipient email address is registered to a user of the electronic communication platform, re-routing the message for delivery as an in-platform message between the accounts of the user and recipient instead of delivering the message to the recipient email address;
wherein the generating and sending steps are only performed if the recipient email address is not registered to a user of the electronic communication platform.

21. The method of claim 19, comprising:
presenting an unsubscribe user interface element to the user in conjunction with the delivery of a message transmitted to the new email address; and
disabling the new email address in response to actuation of the unsubscribe user interface element by the user, thereby preventing any additional messages addressed to the disabled email address from delivery to an inbox of the user.

22. A method of facilitating communication, comprising:
presenting an unsubscribe user interface element to a user in conjunction with the delivery of a message from a particular sender to the user that is addressed to an email address of the user; and
disabling the email address in response to actuation of the unsubscribe user interface element by the user, thereby preventing any additional messages addressed to the disabled email address from delivery to an inbox of the user.

23. The method of claim 22, wherein said presenting an unsubscribe user interface element comprises displaying the unsubscribe user interface element to the user in proximity to contents of the message, even if the original message lacks an unsubscribe hyperlink.

24. A method of facilitating communication within an electronic communication platform, comprising:
delivering, within an electronic communication platform, advertisement messages from an organization to users that subscribe to the organization within the electronic communication platform; and
once a quantity of users that subscribe to the organization within the electronic communication platform has reached a threshold quantity of n subscribers, temporarily increasing a subscription fee for subscribing to the organization within the electronic communication platform for any new subscribers beyond the existing n subscribers from a first amount to a second amount until the organization purchases capacity for additional subscribers in the electronic communication platform.

25. The method of claim 24, wherein the first amount is zero.

26. A method of facilitating communication within an electronic communication platform, comprising:
receiving an advertisement message from an organization;
identifying a plurality of users of an electronic communication platform as recipients for the message; and
for each identified user:
delivering the advertisement message without an indicator that the message is an advertisement if the user has subscribed to the organization within the electronic communication platform; and
delivering the advertisement message with an indicator that the message is an advertisement if the user has not subscribed to the organization within the electronic communication platform.

27. A method of delivering electronic messages, comprising:
receiving, in an electronic communication platform, a message from a sender, the message having a corresponding first appropriateness rating;
delivering the message to a recipient if the recipient is currently using a first device to access the electronic communication platform, the first device being authorized to receive messages having the first appropriateness rating; and
postponing delivery of the message to the recipient if the recipient is currently using a second device to access the electronic platform, the second device being unauthorized to receive messages having the first appropriateness rating.

28. The method of claim 27, comprising:
receiving an instruction from the recipient to classify all messages from the sender as having a second appropriateness rating that is different from the first appropriateness rating;
reclassifying the message as having the second appropriateness rating based on the user instruction prior to delivering the message to the recipient; and
determining whether to deliver or postpone delivery of the message to the recipient based on the second appropriateness rating.
